(19) United States
(12) Patent Application Publication
(10) Pub. No.: US 2010/0182970 A1
(43) Pub. Date: Jul. 22, 2010

(54) Multiple Subscriptions Using a Single Air-Interface Resource

(75) Inventors: George Cherian, San Diego, CA (US); Jun Wang, La Jolla, CA (US); Ravindra M. Patwardhan, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/688,066

(22) Filed: Jan. 15, 2010

Related U.S. Application Data
(60) Provisional application No. 61/146,046, filed on Jan. 21, 2009.

(51) Int. Cl. H04W 4/00; H04M 1/66

(52) U.S. Cl. 370/329; 455/411

(57) ABSTRACT

Aspects describe supporting multiple subscriptions using a single air-interface resource. The multiple subscriptions can be supported by different operators or service providers. The multiple subscriptions include a primary subscription and one or more secondary subscriptions. A radio resource control is associated with the primary subscription and multiple call control signaling, which are decoupled from the radio resource control, are associated with the primary subscription and each of the one or more secondary subscriptions. In some aspects, a high rate packet data authentication is common for the primary subscription and the one or more secondary subscriptions and separate point-to-point protocol sessions, or a similar upper layer Internet Protocol signaling, are authenticated for each of the primary subscription and the one or more secondary subscriptions.

### CROSS-REFERENCE

This is an application claiming priority to Provisional Application No. 61/146,046 entitled “MULTIPLE SUBSCRIPTIONS USING SINGLE AIR-INTERFACE RESOURCE” filed Jan. 21, 2009, and assigned to the assignee hereof and hereby expressly incorporated by reference herein.

### BACKGROUND

I. Field

The following description relates generally to communications networks and more particularly to supporting multiple subscriptions on a single air interface resource.

II. Background

Wireless communication systems are widely deployed to provide various types of communication content, such as voice, data, video, and so forth, and to communicate information regardless of where a user is located (e.g., inside or outside a structure) and whether a user is stationary or moving (e.g., in a vehicle, walking). These systems may be multiple-access systems capable of supporting communication with multiple users by sharing the available systems resources (e.g., bandwidth and transmit power). Multiple-access systems include Frequency Division Multiple Access (FDMA) systems, Time Division Multiple Access (TDMA) systems, Code Division Multiple Access (CDMA) systems, Orthogonal Frequency Division Multiple Access (OFDMA) systems, Third Generation Partnership Project (3GPP) Long Term Evolution (LTE) systems, and others.

Generally, wireless multiple-access communication systems can simultaneously support communication for multiple mobile devices. Each mobile device can communicate with one or more base stations through transmissions on forward and reverse links. The forward link (or downlink) refers to the communication link from base stations to mobile devices. The reverse link (or uplink) refers to the communication link from mobile devices to base stations. These communication links can be established through single-input-single-output (SISO) systems, multiple-input-single-output (MISO) systems, multiple-input-multiple-output (MIMO) systems, and so forth. In addition, mobile devices can communicate with other mobile devices (and/or base stations with other base stations) in peer-to-peer wireless network configurations.

Many people are associated with different subscriptions (with different phone numbers for each of the subscriptions). For example, a person can have a personal mobile device (e.g., personal phone number), a business mobile device (e.g., business phone number), as well as other devices (with respective phone numbers). If this person desires to monitor two or more of the devices (or phone numbers) and to receive incoming communications on either (or both) of the phone numbers at the same time (or substantially the same time), that person either has to carry around multiple devices or has to purchase a device that has internal capability to process more than one number. Devices that have the capability to process multiple numbers have increased internal complexity due to requirements of multiple memories and processing capabilities to execute separate signaling between the mobile device and network for each of the phone numbers. The number of separate memories and processing capabilities is a function of the amount of numbers that the device is equipped to handle. These multiple internal requirements can lead to high costs, short memory life, and other challenges.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

According to an aspect is a method that employs a processor executing computer executable instructions stored on a computer readable storage medium to implement the method. Method can also include receiving a registration request from a mobile device, wherein the registration request is based on a primary subscription. Further, method can include mapping at least one secondary subscription to the primary subscription. Method can also include creating a radio resource control connection with the mobile device based on the primary subscription and establishing a first call control signaling for the primary subscription and a second call control signaling for at least one secondary subscription, wherein the radio resource control connection is used across multiple subscriptions.

Another aspect relates to a wireless communications apparatus that includes a memory and a processor. Memory retains instructions related to receiving, from a mobile device, a primary subscription registration request. Memory retains further instructions related to mapping the primary subscription to one or more secondary subscriptions and creating a radio resource control connection based on the primary subscription. Memory also retains instructions related to establishing a first call control signaling for the primary subscription and a separate call control signaling for each of the one or more secondary subscriptions. Processor is coupled to memory and is configured to execute instructions retained in memory.

Still another aspect relates to a wireless communications apparatus that includes means for receiving a registration request from a mobile device, wherein the registration request is based on a primary subscription. Wireless communications apparatus also include means for mapping at least one secondary subscription to the primary subscription. Further, wireless communications apparatus includes means for creating a radio resource control connection with the mobile device based on the primary subscription and means for establishing a first call control signaling for the primary subscription and a second call control signaling for at least one secondary subscription. According to an aspect, means for mapping further comprises means for mapping one or more mobile directory number subscriptions to at least one of a single international mobile subscriber identity, a single electronic serial number of the mobile device, or a mobile equipment identifier, wherein each of the one or more mobile directory number subscriptions corresponds to a different secondary subscription.

In accordance with some aspects, wireless communications apparatus includes means for accepting a communication for the mobile device and means for paging the mobile device on the primary subscription, wherein the communication is intended for the at least one secondary subscription. Also included in wireless communications apparatus are means for allocating radio resources on the primary subscription based on a reply to the paging from the mobile device and means for indicating with the second call control signaling that the communication is for the at least one secondary subscription. Wireless communications apparatus also includes means for routing the communication to the mobile device though the second call control signaling. Further, wireless communications apparatus includes means for terminating the communication using the radio resources based on a termination request from the mobile device and means for releasing the radio resources on the primary subscription.

According to some aspects, wireless communications apparatus includes means for obtaining a call setup request from the mobile device and means for allocating a traffic channel on the primary subscription, wherein the call setup request is for the at least one secondary subscription. Further, wireless communications apparatus includes means for originating a communication on the at least one secondary subscription with the traffic channel and means for routing the communication though the second call control signaling. Also included in wireless communications apparatus are means for terminating the communication for the at least one secondary subscription using the radio resources based on a termination request from the mobile device and means for releasing the traffic channel on the primary subscription.

In accordance with some aspects, wireless communications apparatus includes means for performing a high rate packet data authentication, wherein the high rate packet data authentication is common for the primary subscription and the at least one secondary subscription. Also included is means for authenticating separate point-to-point protocol sessions, or similar upper layer Internet Protocol signaling, for each of the primary subscription and the at least one secondary subscription.

Another aspect relates to a computer program product, comprising a computer-readable medium. Included in computer-readable medium is a first set of codes for causing a computer to receive, from a mobile device, a registration request on a primary subscription. Also included in computer-readable medium are a second set of codes for causing the computer to map the primary subscription to one or more secondary subscriptions and a third set of codes for causing the computer to create a radio resource control connection based on the primary subscription. Further, computer-readable medium includes a fourth set of codes for causing the computer to decouple call control signaling from the radio resource control connection.

Yet another aspect relates to at least one processor that includes a first module that receives a registration request on a primary subscription. Processor also includes a second module that maps the primary subscription to one or more secondary subscriptions and a third module that creates a radio resource control connection based on the primary subscription. Further, processor includes a fourth module that decouples call control signaling from the radio resource control connection and establishes a first call control signaling for the primary subscription and a separate call control signaling for each of the one or more secondary subscriptions.

Still a further aspect relates to a method that comprises employing a processor executing computer executable instructions stored on a computer readable storage medium to implement the method. Method also includes sending a registration request to a network, wherein the registration request is for a first subscription, and receiving a created radio resource control connection that is based on the first subscription. Further, method includes establishing with the network a first call control signaling for the first subscription and a second call control signaling for a second subscription.

Another aspect relates to a wireless communications apparatus that includes a memory and a processor. Memory retains instructions related to conveying a registration request for a first subscription. Memory also retains instructions related to receiving a radio resource control connection that is based on the first subscription and establishing a first call control signaling for the first subscription and a second call control signaling for the second subscription, wherein the first subscription and the second subscription are supported by a same operator or different operators. Processor is coupled to memory and is configured to execute instructions retained in memory.

Still another aspect relates to a wireless communications apparatus that includes means for sending a registration request to a network, wherein the registration request is for a first subscription. Wireless communications apparatus also includes means for receiving a created radio resource control connection that is based on the first subscription and means for establishing with the network a first call control signaling for the first subscription and a second call control signaling for a second subscription. According to some aspects, means for establishing further comprises means for decoupling the created radio resource control connection from the first call control signaling and the second call control signaling.

In accordance with some aspects, wireless communications apparatus includes means for receiving, from the network, a page on the first subscription, wherein the page includes an indication that a communication is for the second subscription. Also included in wireless communications apparatus is means for obtaining allocated radio resources on the first subscription after a page reply is sent and means for accepting the second call control signaling that indicates the communication is for the second subscription. Further, wireless communications apparatus includes means for utilizing the second call control signaling to receive the communication. Also included in wireless communications apparatus can be means for conveying, to the network, a call end request, wherein the communication is terminated on the radio resources, and means for releasing the radio resources on the first subscription.

According to some aspects, wireless communications apparatus includes means for transmitting a call setup request for the second subscription and means for obtaining an allocated traffic channel on the first subscription. Also included are means for originating a communication on the second subscription with the allocated traffic channel and means for utilizing the second call control signaling to route the communication. Further, wireless communications apparatus can include means for conveying, to the network, a call end request, wherein the communication is terminated on the radio resources and means for releasing the allocated traffic channel on the first subscription.

Yet a further aspect relates to a computer program product comprising a computer-readable medium. Included in computer-readable medium is a first set of codes for causing a computer to send a registration request to a network. Also included in computer-readable medium is a second set of codes for causing the computer to receive a created radio resource control connection that is based on the first subscription and a third set of codes for causing the computer to establish with the network a first call control signaling for the first subscription and a second call control signaling for a second subscription.

Another aspect relates to at least one processor comprising a first module that sends a registration request to a network, wherein the registration request is for a first subscription. Processor also includes a second module that receives a created radio resource control connection that is based on the first subscription and a third module that establishes with the network a first call control signaling for the first subscription and a second call control signaling for the second subscription.

To the accomplishment of the foregoing and related ends, one or more aspects comprise features hereinafter fully described and particularly pointed out in the claims. The following description and annexed drawings set forth in detail certain illustrative features of one or more aspects. These features are indicative, however, of but a few of various ways in which principles of various aspects may be employed. Other advantages and novel features will become apparent from the following detailed description when considered in conjunction with the drawings and the disclosed aspects are intended to include all such aspects and their equivalents.

### BRIEF DESCRIPTION OF THE DRAWINGS

FIG. 1 illustrates a system that supports multiple subscriptions using a single air-interface resource, according to an aspect.

FIG. 2 illustrates an example protocol architecture, in accordance with an aspect.

FIG. 3 illustrates an example call flow for a mobile terminated call setup, according to an aspect.

FIG. 4 illustrates an example call flow for call origination, according to an aspect.

FIG. 5 illustrates a method for facilitating use of multiple subscriptions using a single air-interface resource, in accordance with an aspect.

FIG. 6 illustrates a method for facilitating communications in a communication network, according to various aspects.

FIG. 7 illustrates a method for facilitating a communication originated by a multiple subscription mobile device, according to various aspects.

FIG. 8 illustrates a method for supporting multiple subscriptions, according to an aspect.

FIG. 9 illustrates a method for mobile terminated call setup, according to an aspect.

FIG. 10 illustrates a method for mobile originated call setup, according to an aspect.

FIG. 11 illustrates a system that facilitates using a single air-interface resource for multiple subscriptions in accordance with one or more of the disclosed aspects.

FIG. 12 illustrates an example system that facilitates usage of multiple subscriptions with a single air-interface resource, according to an aspect.

FIG. 13 illustrates an example system that supports multiple subscriptions using a single air-interface resource, according to an aspect.

FIG. 14 illustrates a multiple access wireless communication system according to one or more aspects.

FIG. 15 illustrates an example wireless communication system, according to an aspect.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing these aspects.

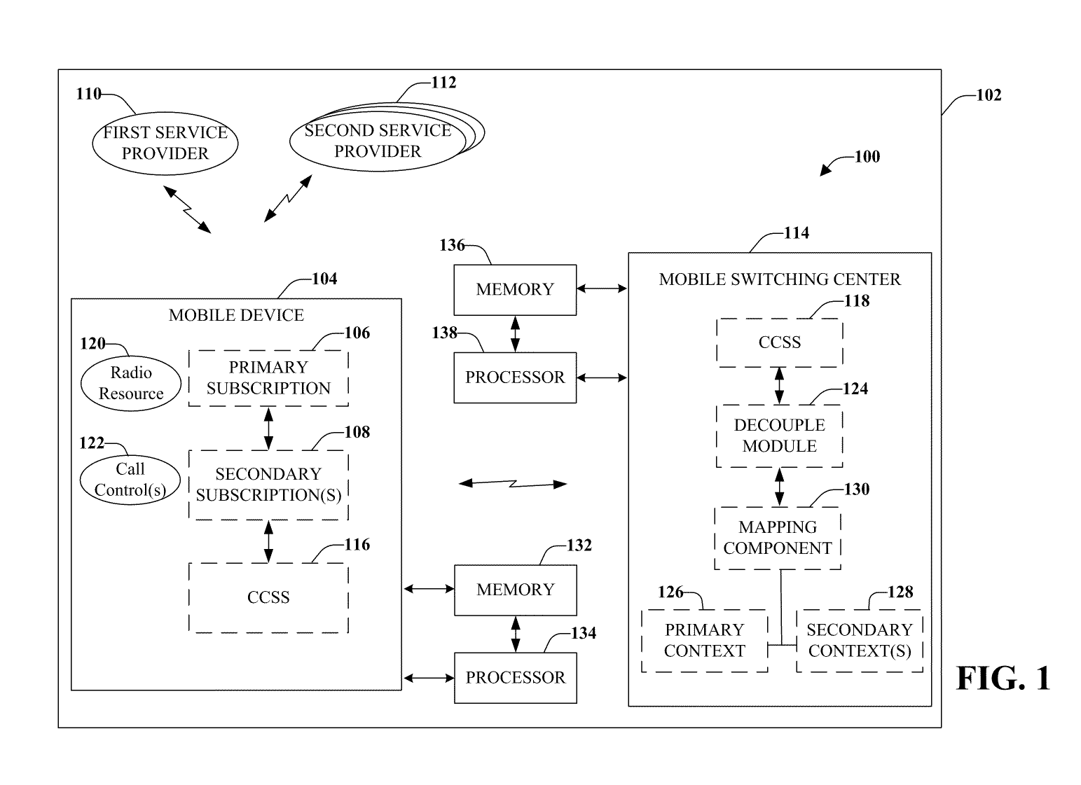

FIG. 1 illustrates a system 100 that supports multiple subscriptions using a single air-interface resource, according to an aspect. Although various devices are discussed herein as being wireless, it should be understood that a subset of the devices can be wired devices. Further, although various aspects will be described with reference to a particular communication technology, the disclosed aspects are not limited to any particular technology and any references to a specific technology are for purposes of describing the disclosed aspects.

System 100 can be employed in a wireless communications environment 102. Included in wireless communications environment 102 can be a plurality of wireless communications apparatuses or user devices (referred to herein as mobile devices), wherein a single mobile device 104 is illustrated for purposes of simplicity. Mobile device 104 can have multiple subscriptions (or multiple phone numbers). For example, a first subscription can be associated with a personal phone (e.g., a first number), a second subscription associated with an office phone (e.g., a second number), and a third subscription associated with another phone (e.g., a third number). For purposes of explanation of the various aspects, one of the subscriptions is identified as a first subscription or primary subscription 106 and the other subscriptions are identified simply as secondary subscription(s) 108.

Further, each subscription can be associated with a single operator or with different operators (or service providers). For example, primary subscription 106 can be associated with a first service provider 110 and each of the secondary subscriptions 108 can be associated with service providers 112 that can be different from first service provider 110 (wherein each secondary subscription can be associated with the same or different service providers). In accordance with some aspects, a subset of the subscriptions can utilize a different communication technology than another subset of subscriptions. According to other aspects, a subset of the subscriptions utilizes different service providers and the same or a different subset of subscriptions utilizes a different communication technology. In some aspects, primary subscription 106 and secondary subscriptions 108 utilize the same service providers and/or the same communication technology.

Traditionally multiple subscription devices, such as mobile device 104, include multiple protocols stacks (one for each subscription) with independent credentials that are combined (e.g., multiple device functionality) in a single device in order to accommodate multiple subscriptions. However, this approach presents several challenges, which include poor battery life, high device cost, idle mode monitoring of pages for time slots corresponding to multiple subscriptions (e.g., conflicting wake-up cycles), and notification of a call on one subscription when the user is active on another subscription (which arises when the device is using a single radio). These challenges can be overcome with the disclosed aspects.

The advantages of the disclosed aspects include mitigating costs associated with mobile devices since one radio resource can be utilized and there is less necessary hardware (e.g., single processor). Another advantage is mitigating battery consumption since the complexity of including processing and other functions (such as independently monitoring multiple paging channels and performing location registration for each of the subscriptions and so forth) of multiple device functionality on a single device is not necessary with the aspects disclosed herein. A further advantage is that there is no impact (or minimal impact depending on different solutions for signaling transportation mechanism) to base station controllers, Radio Access Networks (RANs) and/or Radio Network Controllers (RNCs,) which provides ease of implementation (and mitigates implementation costs and deployment time). This is also an advantage from the system point of view. Yet another advantage is that the same signaling can be utilized (e.g., do not need to set up signaling independently), therefore, the mobile device only has to monitor one slot (e.g., no need to monitor different time slots per subscription) and, therefore, needs to wake-up less frequently.

Also included in system 100 is a network entity or wireless communications apparatus, referred to as a mobile switching center (MSC 114). In order to facilitate multiple subscriptions on a single air-interface resource, MSC 114 can communicate directly with mobile device 104 (e.g., bypassing a base station, which will be discussed in further detail below).

Primary subscription 106 operates in the legacy manner. That is to say if mobile device 104 is associated with only one subscription (e.g., primary subscription 106), mobile device 104 operates in a conventional manner. However, if mobile device 104 is associated with multiple subscriptions, the various aspects disclosed herein can be utilized to provide improved communications.

In order to support the one or more secondary subscriptions 108, mobile device 104 and MSC 114 include a component, referred to as Call Control Signaling for Secondary Subscriptions (CCSS) 116, 118. CCSS 116, 118 is introduced between mobile device 104 and network element that handles the call-control-signaling (MSC 114).

There are at least two aspects related to establishing communications in a communications network. These aspects are a radio resource portion 120 and a call control portion 122. Radio resource portion 120 is assigned though primary subscription 106. Traditionally, call control portion 122 is coupled to the radio resource portion 120, however, in accordance with the disclosed aspects, MSC 114 includes a decouple module 124 that is configured to decouple the radio resource portion 120 from the call control portion 122. Thus, the secondary subscriptions 108 can utilize the radio resource portion 120 of primary subscription 106 (e.g., the secondary subscriptions 108 do not have corresponding radio resource portions themselves). Thus, the radio resource portion 120 is reused across different subscriptions. The signaling for the secondary subscriptions 108 is performed using the primary subscription 106, which will be described in further detail below. In accordance with the disclosed aspects, there can be multiple call control portions 122, wherein the primary subscription 106 and each of the secondary subscriptions 108 are associated with independent call control portions 122. Thus, there is a one-to-many ratio between the radio resource portion 120 and the call control portions 122.

Some characteristics of CCSS 116, 118 are that CCSS 116, 118 is transparent to the air interface protocol (e.g., resources associated with the radio resource portion 120). In other words, CCSS 116, 118 does not care what transport is used, instead CCSS 116, 118 is a mechanism to make registration with the network on a subscription basis, to indicate whether there is a call, if a call is answered, and so forth.

Functions of CCSS 116, 118 include subscription level registration (e.g., indication that mobile device 104 is available for receiving a communication, what primary phone number should be used to page mobile device 104 when a mobile terminated call arrives for the phone number corresponding to this CCSS, and so on). CCSS 116, 118 can support mobile device originated call creation and release and can support mobile device terminated call creation and release. Further, CCSS 116, 118 can support “in call notification”. Thus, if a user of mobile device 104 is already performing a communication on mobile device (e.g., talking), signaling can be provided by CCSS 116, 118 to inform the user that there is another call (on a different subscription). Supplementary services are also supported by CCSS 116, 118 and include call forwarding, call waiting, and so on.

In accordance with some aspects, mobile device 104 includes the capability to allow a device user to configure the device usage and can selectively activate and/or deactivate the primary subscription and/or one or more secondary subscriptions. Each of the subscriptions can be activated and/or deactivated independently from the other subscriptions.

MSC 114 (also referred to as the call control signaling entity) includes a primary subscription context 126 and one or more secondary subscription contexts 128. Further, MSC 114 includes a mapping component 130 that is configured to retain a mapping or association between the primary subscription context 126 and the secondary subscription contexts 128. This mapping allows MSC 114 to page mobile device 104 on the primary subscription 106 when a mobile device terminated call arrives on the secondary subscription 108.

Further, MSC 114 can perform accounting services and management, which includes charging, authorization and accounting for each subscription independently. In accordance with some aspects, mapping component 130 maintains a database (mapping or log) of a phone number (or mobile directory number (MDN)) of the secondary subscriptions 108 and corresponds that number to the phone number (or MDN) of the primary subscription 106. Thus, if a call is received on a personal subscription (secondary subscription 108) and a call is already in process on company subscription (primary subscription 106), MSC 114 (or network) needs to know that there is already a call in process, which can be achieved by associating the primary subscription 106 and the secondary subscriptions 108. In such a manner, each subscription is treated independently for certain functions (e.g., accounting, communication management, and so on).

In accordance with some aspects, the identity that is used for radio resource signaling is the identity that is derived from the primary subscription 106. Thus, MSC 114 associates the radio resource portion 120 with a particular communication (e.g., with a particular subscription) and can perform billing and other record keeping functions, such as how long a communication is in process, where the radio resources are allocated (e.g., which account or subscription should be billed and how much to bill). The charging for secondary subscriptions 108 are derived from the usage of radio resource, etc. of the primary subscription 106 for each of the secondary subscriptions 108.

According to some aspects, MSC 114 can translate multiple mobile device numbers to a single International Mobile Subscriber Identity (IMSI). There is a single IMSI because the IMSI is utilized for various functions, including hashing. Further, with the disclosed aspects, mobile device 104 only has to wake up once to determine if there is a communication for mobile device 104. In accordance with some aspects, there are multiple Mobile Device Identifiers (MDIs) to a single electronic serial number (ESN) of mobile device 104.

In accordance with some aspects, MSC 114 can monitor pages (for mobile device 104) with the first subscription and/or obtain location information (of mobile device 104) based on a location registration on the first subscription. Additionally or alternatively, MSC 114 can obtain maintenance information related to the first subscription, wherein the maintenance information is independent of a subscription related signaling.

System 100 can include memory 132 operatively coupled to mobile device 104. Memory 132 can be external to mobile device 104 or can reside within mobile device 104. Memory 132 can store information related to conveying a registration request for a first subscription. In an aspect, the registration request includes information related to at least a second subscription. In some aspects, a secondary registration may be performed along with the registration request or as a separate registration request at a different time. The separate registration request is associated with the primary registration request. Memory 132 can also store information related to receiving a radio resource control connection that is based on the first subscription and establishing a first call control signaling for the first subscription and a second call control signaling for a second subscription. The first subscription and the second subscription can be supported by a same operator or different operators (or service providers). In accordance with some aspects, the instructions related to establishing further decouples the created radio resource control connection from the first call control signaling and the second call control signaling.

In accordance with some aspects, memory 132 retains further instructions related to receiving a page on the first subscription and sending a page reply. Memory 132 also retains instructions related to obtaining allocated radio resources on the first subscription and accepting the second call control signaling that indicates a communication is for the second subscription. Further, memory 132 retains instructions related to utilizing the second call control signaling to receive the communication. According to some aspects, memory 132 retains further instructions related to conveying a call end request and releasing the radio resources on the first subscription.

Additionally or alternatively, memory 132 retains instructions related to sending a call setup request for the second subscription and obtaining an allocated traffic channel on the first subscription. Memory 132 also retains instructions related to originating a communication on the second subscription with the allocated traffic channel and utilizing the second call control signaling to route the communication. According to some aspects, memory 132 retains further instructions related to conveying a call end request and releasing the allocated traffic channel on the first subscription, wherein the communication is terminated on the radio resources.

Memory 132 can store protocols associated with supporting multiple subscriptions, taking action to control communication between mobile device 104 and other system devices, such that system 100 can employ stored protocols and/or algorithms to achieve improved communications in a wireless network as described herein.

It should be appreciated that data store (e.g., memories) components described herein can be either volatile memory or nonvolatile memory, or can include both volatile and nonvolatile memory. By way of example and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of example and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Memory of the disclosed aspects are intended to comprise, without being limited to, these and other suitable types of memory.

At least one processor 134 can be operatively connected to mobile device 104 (and/or memory 132) to facilitate analysis of information related to multiple subscriptions in a communication network. Processor 134 can be a processor dedicated to analyzing and/or generating information received by mobile device 104, a processor that controls one or more components of system 100, and/or a processor that both analyzes and generates information received by mobile device 104 and controls one or more components of system 100.

In accordance with some aspects, processor 134 is configured to support multiple subscriptions on a single air-interface resource. Processor 134 can include a first module that sends a registration request to a network, wherein the registration request is for a first subscription. Processor 134 also includes a second module that receives a created radio resource control connection that is based on the first subscription. Also included is a third module that establishes with the network a first call control signaling for the first subscription and a second call control signaling for the second subscription. According to some aspects, third module further decouples the created radio resource control connection from the first call control signaling and the second call control signaling.

Further, system 100 can include memory 136 operatively coupled to MSC 114. Memory 136 can be external to MSC 114 or can reside within MSC 114. Memory 136 can store information related to receiving, from mobile device 104, a primary subscription registration request and mapping the primary subscription to one or more secondary subscriptions. Memory 136 can also store information related to creating a radio resource control connection based on the primary subscription and decoupling call control signaling from the radio resource control connection. In accordance with some aspects, the instructions related to decoupling comprises establishing a first call control signaling for the primary subscription and a separate call control signaling for each of the one or more secondary subscriptions.

Additionally, memory 136 retains further instructions related to accepting a communication for the mobile device, wherein the communication is intended for at least one secondary subscription. Memory 136 also retains instructions related to paging the mobile device on the primary subscription and allocating radio resources on the primary subscription based on a reply to the paging from the mobile device. Further, memory 136 retains instructions related to indicating, with the second call control signaling, that the communication is for the at least one secondary subscription and routing the communication to the mobile device though the second call control signaling. Memory 136 also retains instructions related to terminating the communication using the radio resources based on a termination request from the mobile device and releasing the radio resources on the primary subscription.

Additionally or alternatively, memory 136 retains further instructions related to obtaining a call setup request from the mobile device, wherein the call setup request is for the at least one secondary subscription. Memory 136 also retains instructions related to allocating a traffic channel on the primary subscription and originating a communication on the at least one secondary subscription with the traffic channel. Further, memory 136 retains instructions related to routing the communication though the second call control signaling. Memory 136 retains further instructions related to terminating the communication using the radio resources based on a termination request from the mobile device and releasing the traffic channel on the primary subscription.

In accordance with some aspects, memory 136 retains further instructions related to tracking usage of the at least one secondary subscription based on usage of the radio resource control connection. Memory 136 also retains instructions related to charging the usage of the at least one secondary subscription independent from the primary subscription, wherein the radio resource control connection was established using signaling of the primary subscription and converted to the at least one secondary subscription.

Further, memory 136 can store protocols and other suitable information associated with multiple subscription mobile devices within a communications network, taking action to control communication between mobile device 104, MSC 114, and other entities such that system 100 can employ stored protocols and/or algorithms to achieve improved communications in a wireless network as described herein.

At least one processor 138 can be operatively connected to MSC 114 (and/or memory 136) to facilitate analysis of information related to multiple subscriptions in a communication network. Processor 138 can be a processor dedicated to analyzing and/or generating information received by MSC 114, a processor that controls one or more components of system 100, and/or a processor that both analyzes and generates information received by MSC 114 and controls one or more components of system 100.

In accordance with some aspects, processor 138 is configured to facilitate communication with a multiple subscription mobile device. Processor 138 can include a first module that receives a registration request on a primary subscription and a second module that maps the primary subscription to one or more secondary subscriptions. Processor 138 also includes a third module that creates a radio resource control connection based on the primary subscription and a fourth module that decouples call control signaling from the radio resource control connection. The fourth module can further establish a first call control signaling for the primary subscription and a separate call control signaling for each of the one or more secondary subscriptions.

According to some aspects, processor 138 includes a fifth module that performs a high rate packet data authentication, wherein the high rate packet data authentication is common for the primary subscription and the one or more secondary subscriptions. Also included can be a sixth module that authenticates separate point-to-point protocol sessions, or a similar upper layer Internet Protocol (IP) signaling, for each of the primary subscription and the one or more secondary subscriptions.

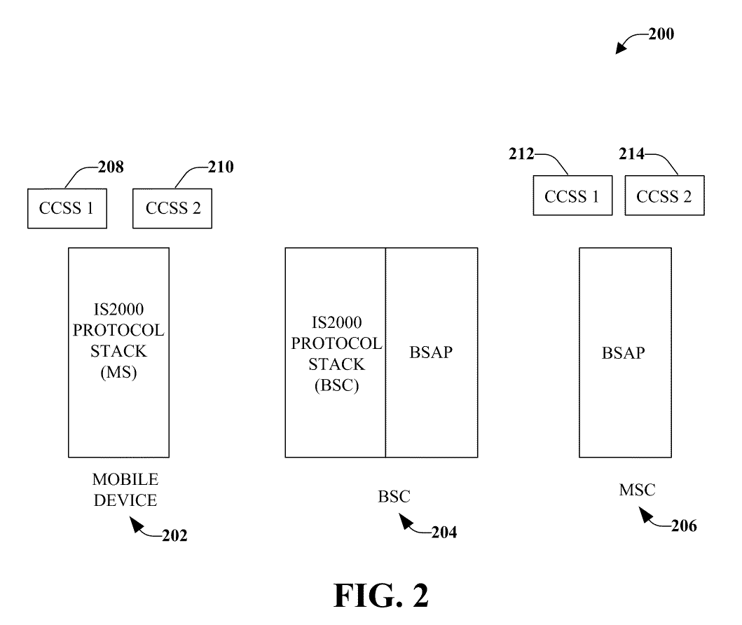

In order to provide context for the disclosed aspects, FIG. 2 illustrates an example protocol architecture 200, in accordance with an aspect. The illustrated protocol architecture 200 is CDMA2000-IS2000 specific, however, the disclosed aspects are not limited to this implementation and other technologies can be utilized.

Protocol architecture 200 includes a mobile device 202, a base station controller (BSC 204), and a mobile switching center (MSC 206). BSC 204 is the entity that is mostly response for radio resource control and MSC 206 is the entity responsible for call control. Mobile device 202 includes multiple CCSSes, two of which are shown and labeled CCSS 1 208 and CCSS 2 210. MSC 206 also has multiple CCSSes, two of which are illustrated as CCSS 1 212 and CCSS 2 214. The BSC 204 is shared by multiple subscriptions (CCSSes). Thus, the same radio resource is shared by multiple subscriptions and is not tied to a single subscription.

A call control state machine of the secondary subscriptions operates based on the signaling messages received on CCSS. CCSS includes registration functions, which includes making an entry in the network so that the network is aware that the subscriber is active and is associated with mobile device 202. Thus, when there is a communication for the mobile subscriber, network knows where to route the communication.

CCSS also includes alert with information. This includes message information that is utilized to inform mobile device 202 that there is a communication, if the traffic channel is already assigned. If the traffic channel is not already assigned, a page can be transmitted to mobile device 202, which bypasses the base station (BSC 204) since base station is only aware of the primary subscription (because radio resources are associated with primary subscription). Thus, the CCSS can be carried over the air-interface signaling message that base station (BSC 204) transparently exchanges between mobile device 202 and MSC 206. For example, the CCSS information can be sent in the payload of a data-burst message that is exchanged between mobile device 202 and MSC 206.

For example, MSC 206 receives a mobile terminated call from a remote party that is for secondary subscription. MSC 206 sends a page to mobile device 202 to bring up the traffic channel. This page is sent using the primary subscription even though the communication came for the secondary subscription. If the page were sent based on the secondary subscription, it would not be received by mobile device 202 because mobile device 202 is on a different wake up cycle (e.g., the cycle established based on the primary subscription). Thus, when a communication arrives, MSC 206 uses the primary subscription to page mobile device 202 and once the traffic channel is up, mobile device 202 uses the alert with information to indicate to the user that the actual call is for the secondary subscription.

CCSS also supports flash with information, which is similar to alert with information described above. Further, CCSS supports data burst, which can be used for Short Message Service (SMS), where a SMS can be sent to the secondary subscription using the primary subscription.

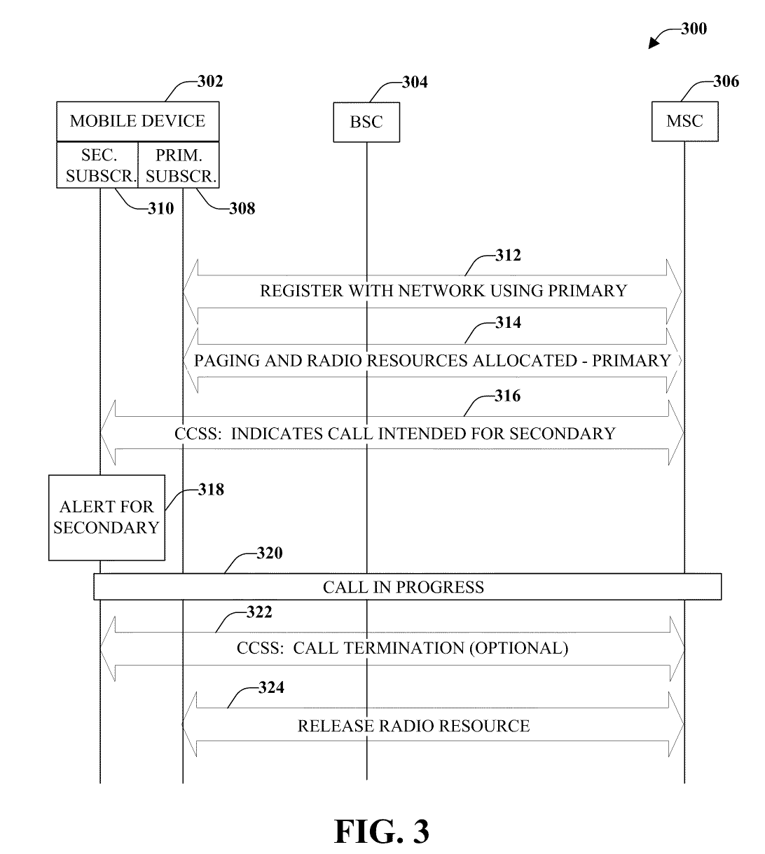

FIG. 3 illustrates an example call flow 300 for a mobile terminated call setup, according to an aspect. Illustrated are a mobile device 302, a base station controller 304, and a mobile switching center 306. Mobile device 302 includes a primary subscription 308 and one or more secondary subscriptions 310.

Mobile device 302 utilizes primary subscription 308 (or primary number), at 312, to register with network or mobile switching center 306. At 314, network (mobile switching center 306) pages mobile device 302 on primary number (primary subscription 308). Mobile device 302 responds to page and radio resources are allocated based on primary subscription 308. The paging occurs on primary subscription 308 even if the communication is intended for secondary subscription 310. If the communication is for secondary subscription 310, the CCSS signaling will indicate the subscription for which the communication is intended, as indicated at 316.

At 318, the mobile switching center 306 sends the communication based on the CCS signaling and mobile device 302 informs the user there is an incoming communication. The notification provided to the user can be configurable. For example, a different ringtone can be established for each of the subscriptions. In another example, a different type of vibration can be utilized for each of the different subscriptions.

The communication (or call) is in process as indicated, at 320. When the communication is over, there is call level signaling to indicate the communication is finished. This signaling can use the radio resource setup established, at 314. It should be noted that call termination, at 322, is optional. At 324, the radio resource is released if there are no calls in progress. Primary subscription 308 is utilized for releasing the radio resources.

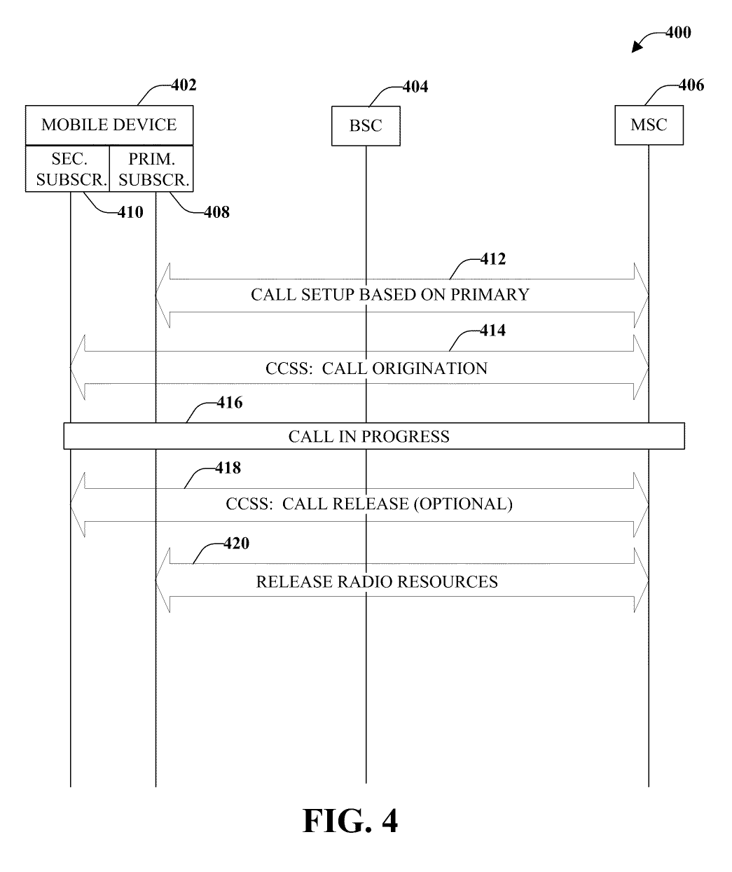

FIG. 4 illustrates an example call flow 400 for call origination, according to an aspect. Illustrated are a mobile device 402, a base station controller 404, and a mobile switching center 406. Mobile device 402 includes a primary subscription 408 and one or more secondary subscriptions 410. Base station controller 404 is only aware of primary subscription 408 and, therefore, utilizes primary subscription 408 for all radio resources. At 412, a call setup and radio resources setup is made based on primary subscription 408 (called party number is not sent). At 414, call origination occurs and can include calling party number, called party number, and so on. CCSS is used for signaling at the call level (e.g., to set up the call, to indicate the call party number, and so forth) using radio resource previously established (at 412).

For example, a multiple subscription device is set up to have a personal phone as the primary subscription and an office phone as a secondary subscription. When a call is to be made using the office phone number, the traffic channel is set up using the personal phone (primary subscription) and that traffic channel is used to signal the other call using the office phone number.

The call is in progress, at 416. When the call is completed, CCSS releases the call (call level signaling), at 418, which is optional. The call can be released using the radio resources setup, at 412. At 420, the radio resources are released if there are no calls in progress. If the radio resource is released, all the secondary calls are released automatically.

As stated earlier, the disclosed aspects can be applied to various technologies. In order to appreciate this, the following will describe how the various aspects can be applied to evolution data optimized (EVDO) technology. EVDO includes a high rate packet data (HRPD) session and a point-to-point protocol (PPP) session. The HRPD session can be shared across different subscriptions and once the HRPD session is established (with primary subscription), when the PPP session is established, there can be multiple PPP sessions for each of the different secondary subscriptions. Thus, there can be two levels of authentication, one during the HRPD authentication and another at the time of PPP authentication.

In view of exemplary systems shown and described above, methodologies that may be implemented in accordance with the disclosed subject matter, will be better appreciated with reference to various flow charts. While, for purposes of simplicity of explanation, methodologies are shown and described as a series of blocks, it is to be understood and appreciated that the claimed subject matter is not limited by the number or order of blocks, as some blocks may occur in different orders and/or at substantially the same time with other blocks from what is depicted and described herein. Moreover, not all illustrated blocks may be required to implement methodologies described herein. It is to be appreciated that functionality associated with blocks may be implemented by software, hardware, a combination thereof or any other suitable means (e.g. device, system, process, component). Additionally, it should be further appreciated that methodologies disclosed throughout this specification are capable of being stored on an article of manufacture to facilitate transporting and transferring such methodologies to various devices. Those skilled in the art will understand and appreciate that a methodology could alternatively be represented as a series of interrelated states or events, such as in a state diagram.

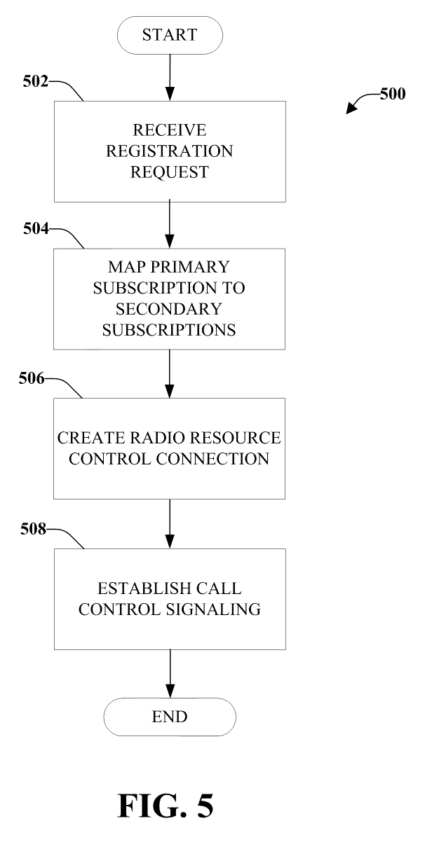

FIG. 5 illustrates a method 500 for facilitating use of multiple subscriptions using a single air-interface resource, in accordance with an aspect. Method 500 can be performed by a network entity, such as a mobile switching center. In accordance with some aspects, method 500 includes employing a processor executing computer executable instructions stored on a computer readable storage medium to implement method 500.

Method 500 starts, at 502, when a registration request is received from a mobile device, which can be a multiple subscription mobile device. The registration request can be based on a primary subscription.

At 504, the secondary subscription is mapped to the primary subscription. If there is more than one secondary subscription, each of the secondary subscriptions is mapped to the primary subscription. Thus, the primary subscription can be mapped to many secondary subscriptions (e.g., one-to-many mapping). According to an aspect, the mapping includes receiving information related to the at least one secondary subscription.

In accordance with some aspects, the mapping includes maintaining independent records for the primary subscription and the one or more secondary subscriptions. These independent records can be maintained for accounting purposes and can include information such as the phone numbers dialed, the phone number from which a communication was received, the time (day, hour, minute) of the communication, the length of the communication, and so forth.

According to some aspects, the mapping, at 504, includes mapping one or more mobile directory number subscriptions to at least one of a single international mobile subscriber identity, a single electronic serial number of the mobile device, or a mobile equipment identifier. Each of the one or more mobile directory number subscriptions can correspond to a different secondary subscription. Each of the one or more mobile directory number subscriptions can correspond to a different secondary subscription.

Method 500 continues, at 506, with creation of a radio resource control connection with the mobile device based on the primary subscription. At 508, call control signaling is established for each of the primary subscription and the one or more secondary subscriptions, wherein the radio resource control connection is used across multiple subscriptions. For example, a first call control signaling can be established for the primary subscription, a second call control signaling can be established for one secondary subscription, a third call control signaling can be established for another secondary subscription, and so forth. In accordance with some aspects, establishing the call control signaling includes decoupling the radio resource control connection for the first call control signaling, the second call control signaling, the third call control signaling, and so forth. In an aspect, method 500 includes associating the radio resource control connection with a secondary subscription if a communication is intended for the secondary subscription.

According to an aspect, method 500 includes tracking usage of the secondary subscriptions based on usage of the radio resource control connection, which was established using signaling of the primary subscription and converted to the secondary subscriptions. Method 500 also includes charging the usage of the secondary subscriptions independent from the primary subscription.

In accordance with some aspects, method 500 can include performing a high rate packet data authentication, wherein the high rate packet data authentication is common for the primary subscription and the at least one secondary subscription. Method 500 can also include authenticating separate point-to-point protocol sessions, or similar upper layer Internet Protocol signaling, for each of the primary subscription and the at least one secondary subscription.

In an aspect, method 500 includes receiving a request (from mobile device) to activate or deactivate the primary subscription and/or one or more secondary subscriptions. Method 500 also includes selectively enabling or disabling the primary subscription and/or the one or more secondary subscriptions independently based on the request.

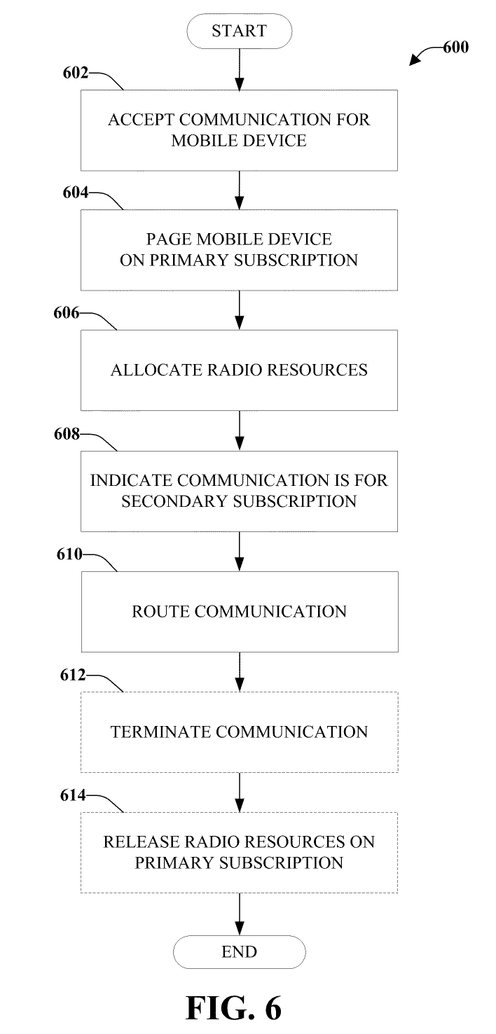

FIG. 6 illustrates a method 600 for facilitating communications in a communication network, according to various aspects. Method 600 can be utilized for mobile terminated call setup and starts, at 602, with accepting a communication for the mobile device. For purposes of describing the disclosed aspects, the communication is for a secondary subscription (e.g., the first secondary subscription). At 604, the mobile device is paged on the primary subscription. This paging bypasses the base station (e.g., no changes are needed to the base station), according to an aspect.

Resources are allocated on the primary subscription, at 606, after a reply to the paging, at 604, is received from the mobile device. To indicate that the communication is for the secondary subscription, at 608, method 600 indicates with the second call control signaling (e.g., the call control signaling associated with the first secondary subscription) that the communication is for secondary subscription. The communication is routed, at 610, to the mobile device through the second call control signaling.

After completion of the communication, method 600 can continue, at 612, with termination of the communication using the radio resources. This termination can be based on receipt of a termination request from the mobile device. At 614, the radio resources on the primary subscription are released.

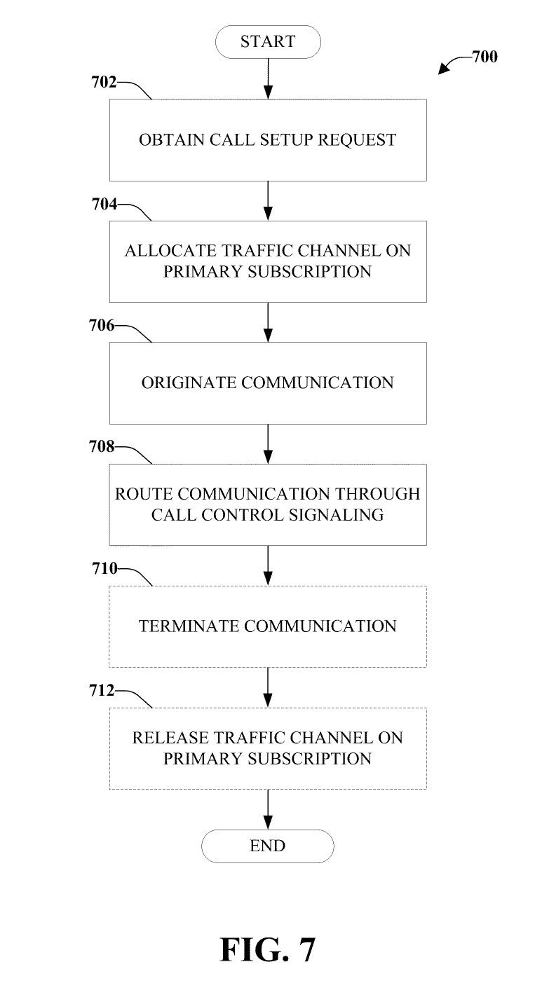

FIG. 7 illustrates a method 700 for facilitating a communication originated by a multiple subscription mobile device, according to various aspects. Method 700 starts, at 702, when a call setup request is obtained from mobile device. For purposes of describing the disclosed aspects, the call setup request is from a secondary subscription (e.g., the first secondary subscription). At 704, a traffic channel is allocated on primary subscription, even though the call setup request was from secondary subscription.

At 706, a communication is originated on the second subscription with the traffic channel and the communication is routed, at 708, though the second call control signaling (e.g., the call control signaling associated with the first secondary subscription).

After completion of the communication, method 700 can continue, at 710, with termination of the communication using the radio resources. This termination can be based on receipt of a termination request from the mobile device. At 712, the traffic channel on the primary subscription is released.

In accordance with some aspects, a computer program product can include a computer-readable medium that comprises codes for carrying out various aspects of methods 500, 600, and/or 700. Computer-readable medium can include a first set of codes for causing a computer to receive a primary subscription registration request and a second set of codes for causing the computer to map the primary subscription to one or more secondary subscriptions. Also included is a third set of codes for causing the computer to create a radio resource control connection based on the primary subscription and a fourth set of codes for causing the computer to decouple call control signaling from the radio resource control connection.

In accordance with some aspects, computer-readable medium further comprises a fifth set of codes for causing the computer to accept a communication for the mobile device, wherein the communication is intended for the at least one secondary subscription. Also included is a sixth set of codes for causing the computer to page the mobile device on the primary subscription and a seventh set of codes for causing the computer to allocate radio resources on the primary subscription based on a reply to the paging. Further, computer-readable medium includes an eighth set of codes for causing the computer to indicate, with the second call control signaling, that the communication is for the at least one secondary subscription and a ninth set of codes for causing the computer to route the communication to the mobile device though the second call control signaling. Also included are a tenth set of codes for causing the computer to terminate the communication using the radio resources based on a termination request from the mobile device and an eleventh set of codes for causing the computer to release the radio resources on the primary subscription.

According to some aspects, computer-readable medium comprises a fifth set of codes for causing the computer to obtain a call setup request from the mobile device, wherein the call setup request is for the at least one secondary subscription. Also included are a sixth set of codes for causing the computer to allocate a traffic channel on the primary subscription and a seventh set of codes for causing the computer to originate a communication on the at least one secondary subscription with the traffic channel. Further, computer-readable medium includes an eighth set of codes for causing the computer to route the communication though the second call control signaling. Computer-readable medium can also include a ninth set of codes for causing the computer to terminate the communication using the radio resources based on a termination request from the mobile device and a tenth set of codes for causing the computer to release the traffic channel on the primary subscription.

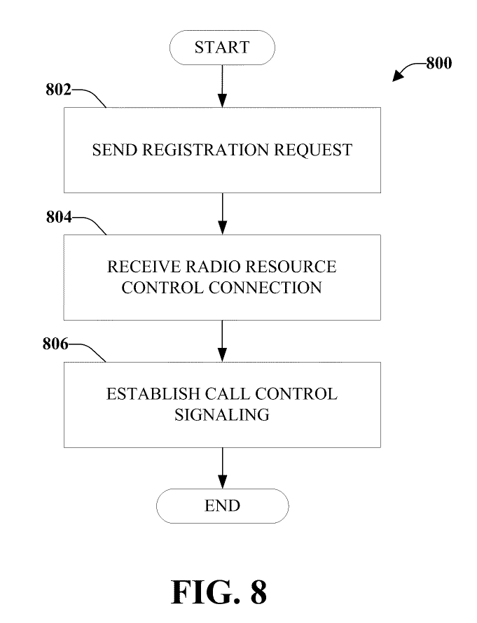

FIG. 8 illustrates a method 800 for supporting multiple subscriptions, according to an aspect. Method 800 can be used by a mobile device and can include employing a processor executing computer executable instructions stored on a computer readable storage medium to implement method 800.

Method 800 starts, at 802, when a registration request is sent to the network. The registration request can be for a first subscription. In an aspect, the registration request includes information related to at least a second subscription. However, in another aspect, information related to other subscriptions can be conveyed at a different time. The first and second subscriptions are with a same service provider or with different service providers.

At 804, a created radio resource control connection that is based on the first subscription is received. Call control signaling is established with the network, at 806. For example, a first call control signaling can be established for the first subscription and a second call control signaling can be established for the second subscription. In accordance with some aspects, the establishing further comprises decoupling the created radio resource control connection from the first call control signaling and the second call control signaling. According to an aspect, the establishing comprises associating the created radio resource control connection with the second subscription if a communication is intended for the second subscription.

In accordance with some aspects, method 800 includes monitoring pages with the first subscription. In another aspect, method 800 includes obtaining location information based on a location registration on the first subscription. Alternatively or additionally, method 800 includes obtaining maintenance information related to the first subscription, wherein the maintenance information is independent of a subscription related signaling.

According to an aspect, method 800 includes receiving a request to activate or deactivate the first subscription or the second subscription and selectively enabling or disabling the first subscription or the second subscription independently based on the request.

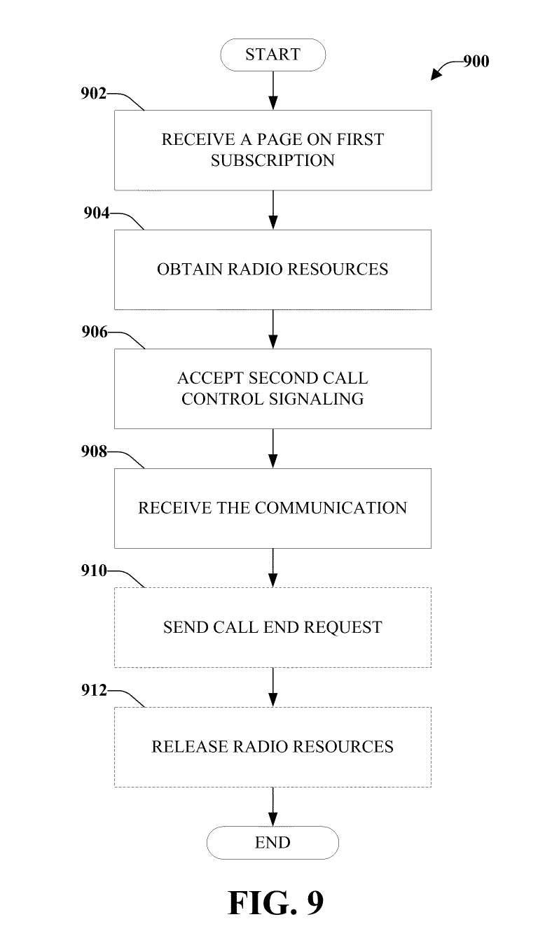

FIG. 9 illustrates a method 900 for mobile terminated call setup, according to an aspect. In this aspect, a call is to be received and method 900 starts at 902, with receiving, from the network, a page on the first subscription. The page includes an indication that a communication is for the second subscription. At 904, allocated radio resources on the first subscription are obtained after a page reply is sent. The second call control signaling is accepted, at 906, and indicates the communication is for the second subscription. At 908, the second call control signaling is utilized to receive the communication.

In accordance with some aspects, method continues, at 910, when a call end request is conveyed to the network. The communication is terminated on the radio resources. At 912, the radio resources on the first subscription are released.

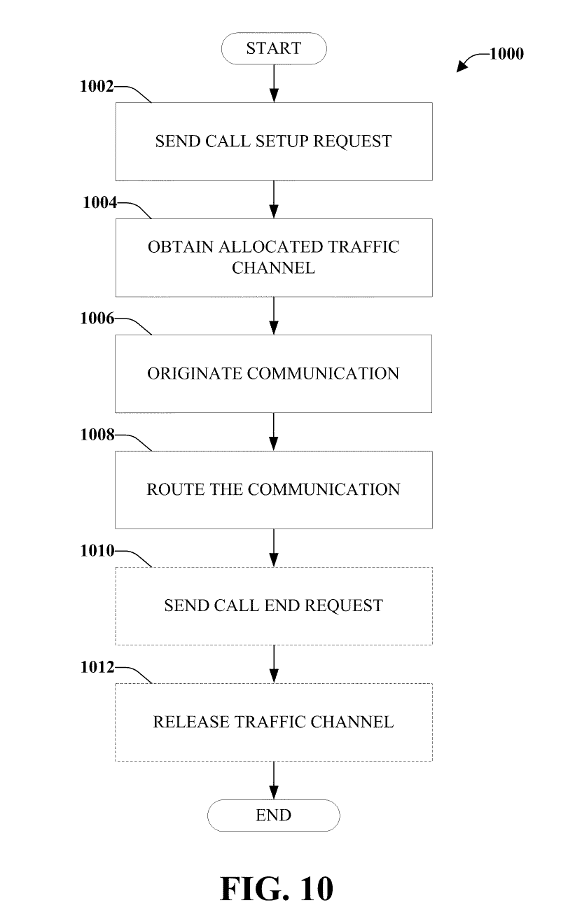

FIG. 10 illustrates a method 1000 for mobile originated call setup, according to an aspect. In accordance with some aspects, a call is to be sent and method 1000 starts, at 1002, when a call setup request for the second subscription is sent to the network. At 1004, an allocated traffic channel on the first subscription is obtained. A communication is originated, at 1006, on the second subscription with the allocated traffic channel. The second call control signaling is utilized, at 1008, to route the communication.

In accordance with some aspects, method 1000 includes, conveying, to the network, at 1010, a call end request, wherein the communication is terminated on the radio resources. At 1012, the allocated traffic channel on the first subscription is released.

In accordance with some aspects, a computer program product can include a computer-readable medium that comprises codes for carrying out various aspects of methods 800, 900, and/or 1000. Computer-readable medium can include a first set of codes for causing a computer to send a registration request to a network, wherein the registration request is for a first subscription. Also included is a second set of codes for causing the computer to receive a created radio resource control connection that is based on the first subscription. Further, computer-readable medium includes a third set of codes for causing the computer to establish with the network a first call control signaling for the first subscription and a second call control signaling for a second subscription. According to some aspects, third set of codes further causes the computer to decouple the created radio resource control connection from the first call control signaling and the second call control signaling.

In accordance with some aspects, computer-readable medium includes a fourth set of codes for causing the computer to receive, from the network, a page on the first subscription, wherein the page includes an indication that a communication is for the second subscription. Also included are a fifth set of codes for causing the computer to obtain allocated radio resources on the first subscription after a page reply is sent and a sixth set of codes for causing the computer to accept the second call control signaling that indicates the communication is for the second subscription. Further, computer readable-medium includes a seventh set of codes for causing the computer to utilize the second call control signaling to receive the communication and an eighth set of codes for causing the computer to convey, to the network, a call end request, wherein the communication is terminated on the radio resources. Also included is a ninth set of codes for causing the computer to release the radio resources on the first subscription.

According to some aspects, computer-readable medium includes a fourth set of codes for causing the computer to send a call setup request for the second subscription. Also included are a fifth set of codes for causing the computer to obtain an allocated traffic channel on the first subscription and a sixth set of codes for causing the computer to originate a communication on the second subscription with the allocated traffic channel. Further, computer-readable medium includes a seventh set of codes for causing the computer to utilize the second call control signaling to route the communication. Also included in computer-readable medium are an eighth set of codes for causing the computer to convey, to the network, a call end request, wherein the communication is terminated on the radio resources and a ninth set of codes for causing the computer to release the allocated traffic channel on the first subscription.

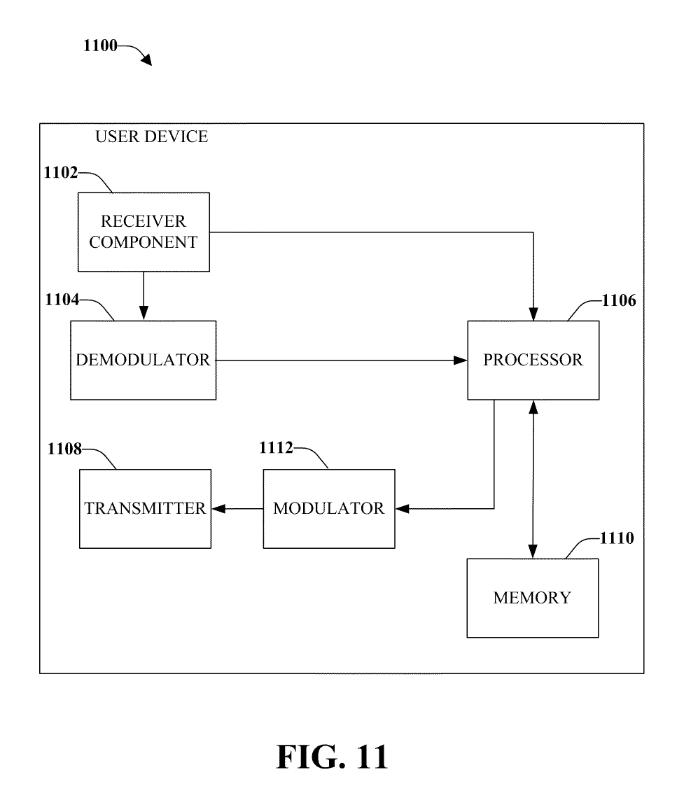

With reference now to FIG. 11, illustrated is a system 1100 that facilitates using a single air-interface resource for multiple subscriptions in accordance with one or more of the disclosed aspects. System 1100 can reside in a multiple subscription user device. System 1100 comprises a receiver component 1102 that can receive a signal from, for example, a receiver antenna. Receiver component 1102 can perform typical actions thereon, such as filtering, amplifying, downconverting, etc. the received signal. Receiver component 1102 can also digitize the conditioned signal to obtain samples. A demodulator 1104 can obtain received symbols for each symbol period, as well as provide received symbols to a processor 1106.

Processor 1106 can be a processor dedicated to analyzing information received by receiver component 1102 and/or generating information for transmission by a transmitter 1108. In addition or alternatively, processor 1106 can control one or more components of system 1100, analyze information received by receiver component 1102, generate information for transmission by transmitter 1108, and/or control one or more components of system 1100. Processor 1106 may include a controller component capable of coordinating communications with additional user devices.

System 1100 can additionally comprise memory 1110 operatively coupled to processor 1106. Memory 1110 can store information related to coordinating communications and any other suitable information. Memory 1110 can additionally store protocols associated with multiple subscriptions. System 1100 can further comprise a symbol modulator 1112, wherein transmitter 1108 transmits the modulated signal.

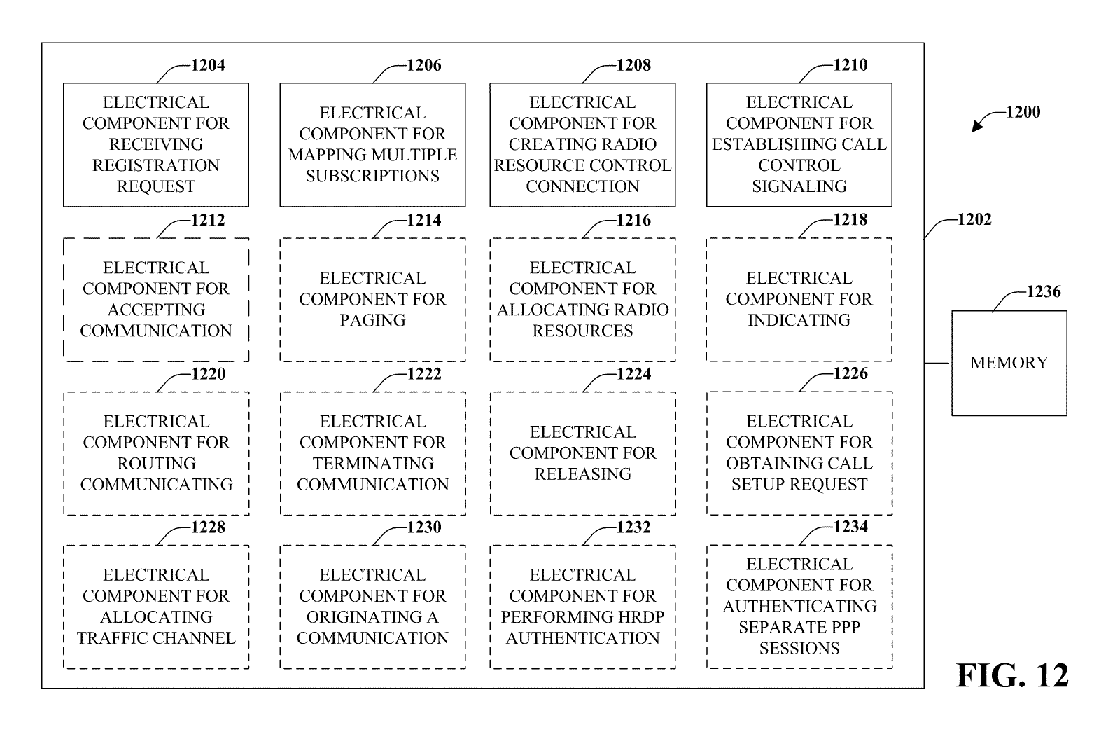

With reference to FIG. 12, illustrated is an example system 1200 that facilitates usage of multiple subscriptions with a single air-interface resource, according to an aspect. System 1200 can reside at least partially within a network entity. It is to be appreciated that system 1200 is represented as including functional blocks, which may be functional blocks that represent functions implemented by a processor, software, or combination thereof (e.g., firmware).

System 1200 includes a logical grouping 1202 of electrical components that can act separately or in conjunction. Logical grouping 1202 includes an electrical component 1204 for receiving a registration request from a mobile device, wherein the registration request is based on a primary subscription. The mobile device is capable of supporting multiple subscriptions.

Also included is an electrical component 1206 for mapping at least one secondary subscription to the primary subscription. In accordance with some aspects, electrical component 1206 includes an electrical component for mapping one or more mobile directory number subscriptions to at least one of: a single international mobile subscriber identity, a single electronic serial number of the mobile device, or a mobile equipment identifier, wherein each of the one or more mobile directory number subscriptions corresponds to a different secondary subscription.

Logical grouping 1202 also includes an electrical component 1208 for creating a radio resource control connection with the mobile device based on the primary subscription and an electrical component 1210 for establishing a first call control signaling for the primary subscription and a second call control signaling for the at least one secondary subscription.

According to an aspect, information related to the at least one secondary subscription is received in the registration request. When a traffic channel is setup, the traffic channel that is setup for the primary subscription is converted for the at least one secondary subscription.

In accordance with some aspects, logical grouping 1202 can include an electrical component 1212 for accepting a communication for the mobile device, wherein the communication is intended for the at least one secondary subscription and an electrical component 1214 for paging the mobile device on the primary subscription. Further, logical grouping 1202 can include an electrical component 1216 for allocating radio resources on the primary subscription based on a reply to the paging from the mobile device and an electrical component 1218 for indicating with the second call control signaling that the communication is for the at least one secondary subscription. Also included is an electrical component 1220 for routing the communication to the mobile device though the second call control signaling and an electrical component 1222 for terminating the communication using the radio resources based on a termination request from the mobile device. Further, logical grouping 1202 includes an electrical component 1224 for releasing the radio resources on the primary subscription.

According to some aspects, logical grouping 1202 includes an electrical component 1226 for obtaining a call setup request from the mobile device, wherein the call setup request is for the at least one secondary subscription. Also included is an electrical component 1228 for allocating a traffic channel on the primary subscription and an electrical component 1230 for originating a communication on the at least one secondary subscription with the traffic channel. Electrical component 1220 routes the communication though the second call control signaling. Upon completion of the communication, electrical component 1222 terminates the communication using the radio resources based on a termination request from the mobile device and electrical component 1224 releases the traffic channel on the primary subscription.

In accordance with some aspects, logical grouping 1202 includes an electrical component 1232 for performing a high rate packet data authentication, wherein the high rate packet data authentication is common for the primary subscription and the at least one secondary subscription. Also included is an electrical component 1234 for authenticating separate point-to-point protocol sessions (or similar upper layer IP signaling) for each of the primary subscription and the at least one secondary subscription.

Additionally, system 1200 can include a memory 1236 that retains instructions for executing functions associated with electrical components 1204-1234 or other components. While shown as being external to memory 1236, it is to be understood that one or more of electrical components 1204-1234 may exist within memory 1236.

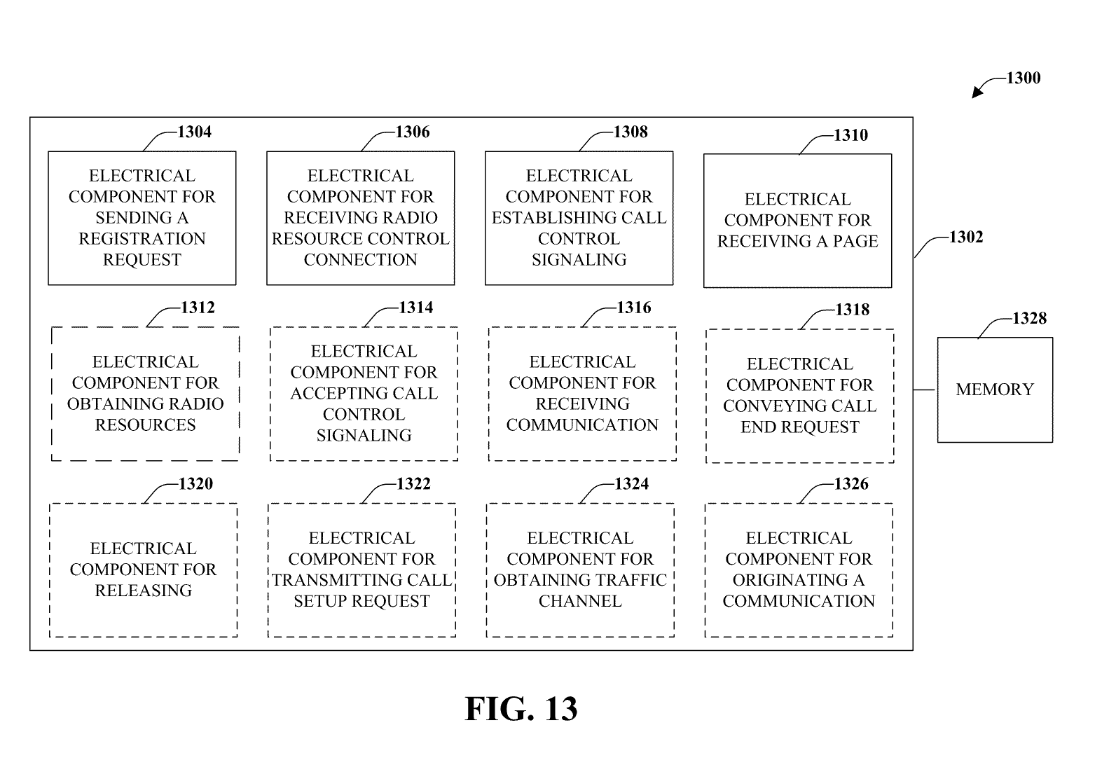

FIG. 13 illustrates an example system 1300 that supports multiple subscriptions using a single air-interface resource, according to an aspect. System 1300 can reside at least partially within a mobile device. System 1300 is represented as including functional blocks, which may be functional blocks that represent functions implemented by a processor, software, or combination thereof (e.g., firmware).

System 1300 includes a logical grouping 1302 of electrical components that can act separately or in conjunction. Logical grouping 1302 includes an electrical component 1304 for sending a registration request to a network. The registration request can be for a first subscription. Also included is an electrical component 1306 for receiving a created radio resource control connection that is based on the first subscription. Logical grouping 1302 also includes an electrical component 1308 for establishing with the network a first call control signaling for the first subscription and a second call control signaling for the second subscription.

In accordance with some aspects, logical grouping 1302 includes an electrical component 1310 for receiving, from the network, a page on the first subscription. The page includes an indication that a communication is for the second subscription. Also included are an electrical component 1312 for obtaining allocated radio resources on the first subscription after a page reply is sent and an electrical component 1314 for accepting the second call control signaling that indicates the communication is for the second subscription. Further, logical grouping 1302 includes an electrical component 1316 for utilizing the second call control signaling to receive the communication. Logical grouping can also include an electrical component 1318 for conveying, to the network, a call end request, wherein the communication is terminated on the radio resources and an electrical component 1320 for releasing the radio resources on the first subscription.

According to some aspects, logical grouping 1302 includes an electrical component 1322 for transmitting a call setup request for the second subscription and an electrical component 1324 for obtaining an allocated traffic channel on the first subscription. Also included is an electrical component 1326 for originating a communication on the second subscription with the allocated traffic channel. Electrical component 1316 utilizes the second call control signaling to route the communication. Further, electrical component 1318 conveys, to the network, a call end request, wherein the communication is terminated on the radio resources and electrical component 1320 releases the allocated traffic channel on the first subscription.

System 1300 can include a memory 1328 that retains instructions for executing functions associated with electrical components 1304-1326 or other components. While shown as being external to memory 1328, it is to be understood that one or more of electrical components 1304-1326 can exist within memory 1328.

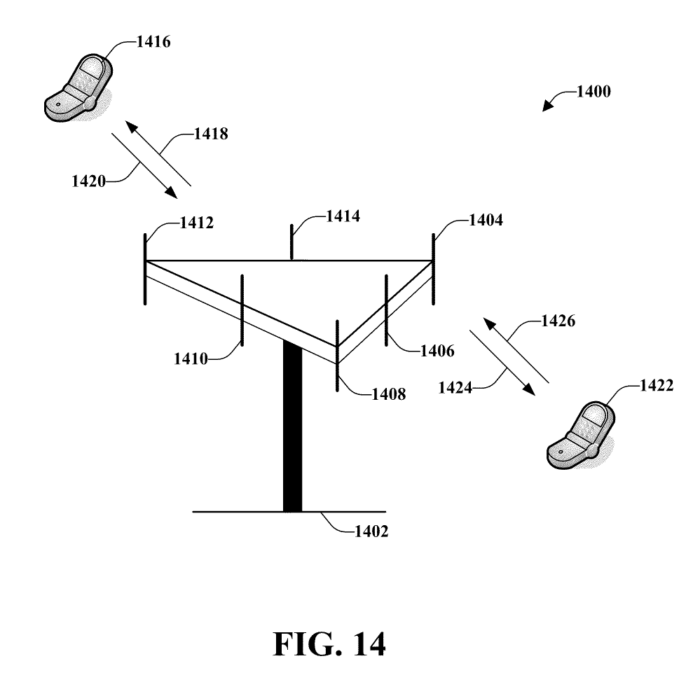

Referring now to FIG. 14, a multiple access wireless communication system 1400 according to one or more aspects is illustrated. A wireless communication system 1400 can include one or more base stations in contact with one or more user devices. Each base station provides coverage for a plurality of sectors. A three-sector base station 1402 is illustrated that includes multiple antenna groups, one including antennas 1404 and 1406, another including antennas 1408 and 1410, and a third including antennas 1412 and 1414. According to the figure, only two antennas are shown for each antenna group, however, more or fewer antennas may be utilized for each antenna group. Mobile device 1416 is in communication with antennas 1412 and 1414, where antennas 1412 and 1414 transmit information to mobile device 1416 over forward link 1418 and receive information from mobile device 1416 over reverse link 1420. Forward link (or downlink) refers to communication link from base stations to mobile devices, and reverse link (or uplink) refers to communication link from mobile devices to base stations. Mobile device 1422 is in communication with antennas 1404 and 1406, where antennas 1404 and 1406 transmit information to mobile device 1422 over forward link 1424 and receive information from mobile device 1422 over reverse link 1426. In a FDD system, for example, communication links 1418, 1420, 1424, and 1426 might utilize different frequencies for communication. For example, forward link 1418 might use a different frequency than the frequency utilized by reverse link 1420.

Each group of antennas and/or the area in which they are designated to communicate may be referred to as a sector of base station 1402. In one or more aspects, antenna groups each are designed to communicate to mobile devices in a sector or the areas covered by base station 1402. A base station may be a fixed station used for communicating with mobile devices.

In communication over forward links 1418 and 1424, transmitting antennas of base station 1402 can utilize beamforming in order to improve a signal-to-noise ratio of forward links for different mobile devices 1416 and 1422. Also, a base station utilizing beamforming to transmit to mobile devices scattered randomly through its coverage area might cause less interference to mobile devices in neighboring cells than the interference that can be caused by a base station transmitting through a single antenna to all mobile devices in its coverage area.

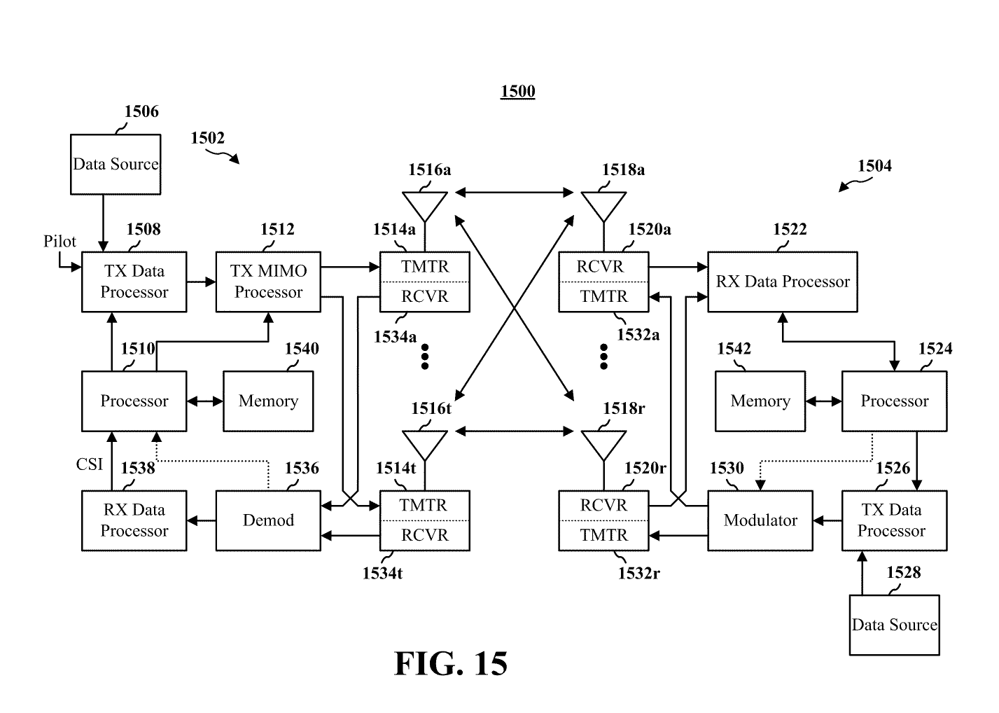

FIG. 15 illustrates an example wireless communication system 1500. The wireless communication system 1500 depicts one base station 1502 and one mobile device 1504 for sake of brevity. However, it is to be appreciated that system 1500 can include more than one base station and/or more than one mobile device, wherein additional base stations and/or mobile devices can be substantially similar or different from example base station 1502 and mobile device 1504 described below. In addition, it is to be appreciated that base station 1502 and/or mobile device 1504 can employ the systems and/or methods described herein to facilitate wireless communication there between.

At base station 1502, traffic data for a number of data streams is provided from a data source 1506 to a transmit (TX) data processor 1508. According to an example, each data stream can be transmitted over a respective antenna. TX data processor 1508 formats, codes, and interleaves the traffic data stream based on a particular coding scheme selected for that data stream to provide coded data.

The coded data for each data stream can be multiplexed with pilot data using orthogonal frequency division multiplexing (OFDM) techniques. Additionally or alternatively, the pilot symbols can be frequency division multiplexed (FDM), time division multiplexed (TDM), or code division multiplexed (CDM). The pilot data is typically a known data pattern that is processed in a known manner and can be used at mobile device 1504 to estimate channel response. The multiplexed pilot and coded data for each data stream can be modulated (e.g., symbol mapped) based on a particular modulation scheme (e.g., binary phase-shift keying (BPSK), quadrature phase-shift keying (QPSK), M-phase-shift keying (M-PSK), M-quadrature amplitude modulation (M-QAM), etc.) selected for that data stream to provide modulation symbols. The data rate, coding, and modulation for each data stream can be determined by instructions performed or provided by processor 1510.

The modulation symbols for the data streams can be provided to a TX MIMO processor 1512, which can further process the modulation symbols (e.g., for OFDM). TX MIMO processor 1512 then provides N_{T} modulation symbol streams to N_{T} transmitters (TMTR) 1514a through 1514t. In various embodiments, TX MIMO processor 1512 applies beamforming weights to the symbols of the data streams and to the antenna from which the symbol is being transmitted.

Each transmitter 1514 receives and processes a respective symbol stream to provide one or more analog signals, and further conditions (e.g., amplifies, filters, and upconverts) the analog signals to provide a modulated signal suitable for transmission over the MIMO channel. Further, N_{T} modulated signals from transmitters 1514a through 1514t are transmitted from N_{T} antennas 1516a through 1516t, respectively.

At mobile device 1504, the transmitted modulated signals are received by N_{R} antennas 1518a through 1518r and the received signal from each antenna 1518 is provided to a respective receiver (RCVR) 1520a through 1520r. Each receiver 1520 conditions (e.g., filters, amplifies, and downconverts) a respective signal, digitizes the conditioned signal to provide samples, and further processes the samples to provide a corresponding “received” symbol stream.

An RX data processor 1522 can receive and process the N_{R} received symbol streams from N_{R} receivers 1520 based on a particular receiver processing technique to provide N_{T} “detected” symbol streams. RX data processor 1522 can demodulate, deinterleave, and decode each detected symbol stream to recover the traffic data for the data stream. The processing by RX data processor 1522 is complementary to that performed by TX MIMO processor 1512 and TX data processor 1508 at base station 1502.

A processor 1524 can periodically determine which precoding matrix to utilize as discussed above. Further, processor 1524 can formulate a reverse link message comprising a matrix index portion and a rank value portion.

The reverse link message can comprise various types of information regarding the communication link and/or the received data stream. The reverse link message can be processed by a TX data processor 1526, which also receives traffic data for a number of data streams from a data source 1528, modulated by a modulator 1530, conditioned by transmitters 1532a through 1532r, and transmitted back to base station 1502.

At base station 1502, the modulated signals from mobile device 1504 are received by antennas 1516, conditioned by receivers 1534a though 1534t, demodulated by a demodulator 1536, and processed by a RX data processor 1538 to extract the reverse link message transmitted by mobile device 1504. Further, processor 1510 can process the extracted message to determine which precoding matrix to use for determining the beamforming weights.

Processors 1510 and 1524 can direct (e.g., control, coordinate, manage, etc.) operation at base station 1502 and mobile device 1504, respectively. Respective processors 1510 and 1524 can be associated with memory 1540 and 1542 that store program codes and data. Processors 1510 and 1524 can also perform computations to derive frequency and impulse response estimates for the uplink and downlink, respectively.

It is to be understood that the embodiments described herein can be implemented in hardware, software, firmware, middleware, microcode, or any combination thereof. For a hardware implementation, the processing units can be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof.

When the embodiments are implemented in software, firmware, middleware or microcode, program code or code segments, they can be stored in a machine-readable medium, such as a storage component. A code segment can represent a procedure, a function, a subprogram, a program, a routine, a subroutine, a module, a software package, a class, or any combination of instructions, data structures, or program statements. A code segment can be coupled to another code segment or a hardware circuit by passing and/or receiving information, data, arguments, parameters, or memory contents. Information, arguments, parameters, data, etc. can be passed, forwarded, or transmitted using any suitable means including memory sharing, message passing, token passing, network transmission, etc.

It is to be understood that aspects described herein may be implemented by hardware, software, firmware, or any combination thereof. When implemented in software, functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if software is transmitted from a website, server, or other remote source using a coaxial cable, fiber optic cable, twisted pair, digital subscriber line (DSL), or wireless technologies such as infrared, radio, and microwave, then coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Various illustrative logics, logical blocks, modules, and circuits described in connection with aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform functions described herein. A general-purpose processor may be a microprocessor, but, in the alternative, processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described herein.

For a software implementation, techniques described herein may be implemented with modules (e.g., procedures, functions, and so on) that perform functions described herein. Software codes may be stored in memory units and executed by processors. Memory unit may be implemented within processor or external to processor, in which case memory unit can be communicatively coupled to processor through various means as is known in the art. Further, at least one processor may include one or more modules operable to perform functions described herein.

Techniques described herein may be used for various wireless communication systems such as CDMA, TDMA, FDMA, OFDMA, SC-FDMA and other systems. The terms “system” and “network” are often used interchangeably. A CDMA system may implement a radio technology such as Universal Terrestrial Radio Access (UTRA), CDMA2000, etc. UTRA includes Wideband-CDMA (W-CDMA) and other variants of CDMA. Further, CDMA2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) is a release of UMTS that uses E-UTRA, which employs OFDMA on downlink and SC-FDMA on uplink. UTRA, E-UTRA, UMTS, LTE and GSM are described in documents from an organization named “3rd Generation Partnership Project” (3GPP). Additionally, CDMA2000 and UMB are described in documents from an organization named “3rd Generation Partnership Project 2” (3GPP2). Further, such wireless communication systems may additionally include peer-to-peer (e.g., mobile-to-mobile) ad hoc network systems often using unpaired unlicensed spectrums, 802.xx wireless LAN, BLUETOOTH and any other short- or long-range, wireless communication techniques.

Single carrier frequency division multiple access (SC-FDMA), which utilizes single carrier modulation and frequency domain equalization is a technique that can be utilized with the disclosed aspects. SC-FDMA has similar performance and essentially a similar overall complexity as those of OFDMA system. SC-FDMA signal has lower peak-to-average power ratio (PAPR) because of its inherent single carrier structure. SC-FDMA can be utilized in uplink communications where lower PAPR can benefit a mobile terminal in terms of transmit power efficiency.

Moreover, various aspects or features described herein may be implemented as a method, apparatus, or article of manufacture using standard programming and/or engineering techniques. The term “article of manufacture” as used herein is intended to encompass a computer program accessible from any computer-readable device, carrier, or media. For example, computer-readable media can include but are not limited to magnetic storage devices (e.g., hard disk, floppy disk, magnetic strips, etc.), optical disks (e.g., compact disk (CD), digital versatile disk (DVD), etc.), smart cards, and flash memory devices (e.g., EPROM, card, stick, key drive, etc.). Additionally, various storage media described herein can represent one or more devices and/or other machine-readable media for storing information. The term “machine-readable medium” can include, without being limited to, wireless channels and various other media capable of storing, containing, and/or carrying instruction(s) and/or data. Additionally, a computer program product may include a computer readable medium having one or more instructions or codes operable to cause a computer to perform functions described herein.

Further, the steps and/or actions of a method or algorithm described in connection with aspects disclosed herein may be embodied directly in hardware, in a software module executed by a processor, or a combination thereof. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to processor, such that processor can read information from, and write information to, storage medium. In the alternative, storage medium may be integral to processor. Further, in some aspects, processor and storage medium may reside in an ASIC. Additionally, ASIC may reside in a user terminal. In the alternative, processor and storage medium may reside as discrete components in a user terminal. Additionally, in some aspects, the steps and/or actions of a method or algorithm may reside as one or any combination or set of codes and/or instructions on a machine-readable medium and/or computer readable medium, which may be incorporated into a computer program product.

While the foregoing disclosure discusses illustrative aspects and/or embodiments, it should be noted that various changes and modifications could be made herein without departing from the scope of described aspects and/or embodiments as defined by the appended claims. Accordingly, described aspects are intended to embrace all such alterations, modifications and variations that fall within scope of appended claims. Furthermore, although elements of described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

To the extent that the term “includes” is used in either the detailed description or the claims, such term is intended to be inclusive in a manner similar to the term “comprising” as “comprising” is interpreted when employed as a transitional word in a claim. Furthermore, the term “or” as used in either the detailed description or the claims is intended to mean an inclusive “or” rather than an exclusive “or”. That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

As used in this application, the terms “component”, “module”, “system”, and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. Components may communicate by way of local and/or remote processes such as in accordance with a signal having one or more data packets (e.g., data from one component interacting with another component in a local system, distributed system, and/or across a network such as the Internet with other systems by way of the signal).

Furthermore, various aspects are described herein in connection with a mobile device. A mobile device can also be called, and may contain some or all of the functionality of a system, subscriber unit, subscriber station, mobile station, mobile, wireless terminal, node, device, remote station, remote terminal, access terminal, user terminal, terminal, wireless communication device, wireless communications apparatus, user agent, user device, or user equipment (UE), and the like. A mobile device can be a cellular telephone, a cordless telephone, a Session Initiation Protocol (SIP) phone, a smart phone, a wireless local loop (WLL) station, a personal digital assistant (PDA), a laptop, a handheld communication device, a handheld computing device, a satellite radio, a wireless modem card and/or another processing device for communicating over a wireless system. Moreover, various aspects are described herein in connection with a base station. A base station may be utilized for communicating with wireless terminal(s) and can also be called, and may contain some or all of the functionality of, an access point, node, Node B, e-NodeB, e-NB, wireless communications apparatus, or some other network entity.

Various aspects or features are presented in terms of systems that may include a number of devices, components, modules, and the like. It is to be understood and appreciated that various systems may include additional devices, components, modules, and so forth, and/or may not include all devices, components, modules, and so on, discussed in connection with the figures. A combination of these approaches may also be used.

Additionally, in the subject description, the word “exemplary” (and variants thereof) is used to mean serving as an example, instance, or illustration. Any aspect or design described herein as “exemplary” is not necessarily to be construed as preferred or advantageous over other aspects or designs. Rather, use of the word “exemplary” is intended to present concepts in a concrete manner.

What is claimed is:

1. A method of employing a processor executing computer executable instructions stored on a computer readable storage medium, comprising:
receiving a registration request from a mobile device, wherein the registration request is based on a primary subscription;
mapping at least one secondary subscription to the primary subscription;
creating a radio resource control connection with the mobile device based on the primary subscription; and
establishing a first call control signaling for the primary subscription and a second call control signaling for at least one secondary subscription, wherein the radio resource control connection is used across multiple subscriptions.

2. The method of claim 1, wherein the mapping comprises receiving information related to the at least one secondary subscription.

3. The method of claim 1, further comprising:
accepting a communication for the mobile device, wherein the communication is intended for the at least one secondary subscription;
paging the mobile device on the primary subscription;
allocating radio resources on the primary subscription based on a reply to the paging;
indicating with the second call control signaling that the communication is for the at least one secondary subscription; and
routing the communication to the mobile device though the second call control signaling.

4. The method of claim 3, further comprising:
terminating the communication using the radio resources based on a termination request from the mobile device; and
releasing the radio resources on the primary subscription.

5. The method of claim 1, further comprising:
obtaining a call setup request from the mobile device, wherein the call setup request is for the at least one secondary subscription;
allocating a traffic channel on the primary subscription;
originating a communication on the at least one secondary subscription with the traffic channel; and
routing the communication though the second call control signaling.

6. The method of claim 5, further comprising:
terminating the communication using radio resources based on a termination request from the mobile device; and
releasing the traffic channel on the primary subscription.

7. The method of claim 1, further comprising:
associating the radio resource control connection with the at least one secondary subscription if a communication is intended for the at least one secondary subscription.

8. The method of claim 1, further comprising:
receiving a request to activate or deactivate the primary subscription or the at least one secondary subscription; and
selectively enabling or disabling the primary subscription or the at least one secondary subscription independently based on the request.

9. The method of claim 1, wherein the mapping further comprising maintaining independent records for the primary subscription and the at least one secondary subscription.

10. The method of claim 1, wherein the mapping further comprising mapping one or more mobile directory number subscriptions to at least one of a single international mobile subscriber identity, a single electronic serial number of the mobile device, or a mobile equipment identifier, wherein each of the one or more mobile directory number subscriptions corresponds to a different secondary subscription.

11. The method of claim 1, further comprising:
tracking usage of the at least one secondary subscription based on usage of the radio resource control connection, wherein the radio resource control connection was established using signaling of the primary subscription and converted to the at least one secondary subscription; and
charging the usage of the at least one secondary subscription independent from the primary subscription.

12. The method of claim 1, further comprising:
performing a high rate packet data authentication, wherein the high rate packet data authentication is common for the primary subscription and the at least one secondary subscription; and
authenticating separate point-to-point protocol sessions, or similar upper layer Internet Protocol signaling, for each of the primary subscription and the at least one secondary subscription.

13. A wireless communications apparatus, comprising:
a memory that retains instructions related to receiving, from a mobile device, a primary subscription registration request, mapping a primary subscription to one or more secondary subscriptions, creating a radio resource control connection based on the primary subscription, and establishing a first call control signaling for the primary subscription and a separate call control signaling for each of the one or more secondary subscriptions; and
a processor, coupled to the memory, configured to execute the instructions retained in the memory.

14. The wireless communications apparatus of claim 13, wherein the memory retains further instructions related to accepting a communication for the mobile device, wherein the communication is intended for the one or more secondary subscriptions, paging the mobile device on the primary subscription, allocating radio resources on the primary subscription based on a reply to the paging from the mobile device, indicating with a second call control signaling that the communication is for the one or more secondary subscriptions, routing the communication to the mobile device though the second call control signaling, terminating the communication using the radio resources based on a termination request from the mobile device, and releasing the radio resources on the primary subscription.

15. The wireless communications apparatus of claim 13, wherein the memory retains further instructions related to obtaining a call setup request from the mobile device, wherein the call setup request is for one of the one or more secondary subscriptions, allocating a traffic channel on the primary subscription, originating a communication on the one of the one or more secondary subscriptions with the traffic channel, routing the communication though a second call control signaling, terminating the communication using radio resources based on a termination request from the mobile device, and releasing the traffic channel on the primary subscription.

16. The wireless communications apparatus of claim 13, wherein the memory retains further instructions related to tracking usage of the one or more secondary subscriptions based on usage of the radio resource control connection and charging the usage of the one or more secondary subscriptions independent from each other and from the primary subscription wherein the radio resource control connection was establish using signaling of the primary subscription and converted to the one or more secondary subscriptions.

17. A wireless communications apparatus, comprising:
means for receiving a registration request from a mobile device, wherein the registration request is based on a primary subscription;
means for mapping at least one secondary subscription to the primary subscription;
means for creating a radio resource control connection with the mobile device based on the primary subscription; and
means for establishing a first call control signaling for the primary subscription and a second call control signaling for the at least one secondary subscription.

18. The wireless communications apparatus of claim 17, further comprising:
means for accepting a communication for the mobile device, wherein the communication is intended for the at least one secondary subscription;
means for paging the mobile device on the primary subscription;
means for allocating radio resources on the primary subscription based on a reply to the paging from the mobile device;
means for indicating with the second call control signaling that the communication is for the at least one secondary subscription;
means for routing the communication to the mobile device though the second call control signaling;
means for terminating the communication using the radio resources based on a termination request from the mobile device; and
means for releasing the radio resources on the primary subscription.

19. The wireless communications apparatus of claim 17, further comprising:
means for obtaining a call setup request from the mobile device, wherein the call setup request is for the at least one secondary subscription;
means for allocating a traffic channel on the primary subscription;
means for originating a communication on the at least one secondary subscription with the traffic channel;
means for routing the communication though the second call control signaling;
means for terminating the communication using radio resources based on a termination request from the mobile device; and
means for releasing the traffic channel on the primary subscription.

20. The wireless communications apparatus of claim 17, further comprising:
means for performing a high rate packet data authentication, wherein the high rate packet data authentication is common for the primary subscription and the at least one secondary subscription; and
means for authenticating separate point-to-point protocol sessions, or similar upper layer Internet Protocol signaling, for each of the primary subscription and the at least one secondary subscription.

21. A computer program product, comprising:
a computer-readable medium comprising:
a first set of codes for causing a computer to receive, from a mobile device, a registration request on a primary subscription;
a second set of codes for causing the computer to map the primary subscription to one or more secondary subscriptions;
a third set of codes for causing the computer to create a radio resource control connection based on the primary subscription; and
a fourth set of codes for causing the computer to decouple call control signaling from the radio resource control connection.

22. The computer program product of claim 21, the computer-readable medium further comprising:
a fifth set of codes for causing the computer to accept a communication for the mobile device, wherein the communication is intended for the one or more secondary subscriptions;
a sixth set of codes for causing the computer to page the mobile device on the primary subscription;
a seventh set of codes for causing the computer to allocate radio resources on the primary subscription based on a reply to the paging;
an eighth set of codes for causing the computer to indicate, with a second call control signaling, that the communication is for the one or more secondary subscriptions;
a ninth set of codes for causing the computer to route the communication to the mobile device though the second call control signaling;
a tenth set of codes for causing the computer to terminate the communication using the radio resources based on a termination request from the mobile device; and
an eleventh set of codes for causing the computer to release the radio resources on the primary subscription.

23. The computer program product of claim 21, the computer-readable medium further comprising:
a fifth set of codes for causing the computer to obtain a call setup request from the mobile device, wherein the call setup request is for the one or more secondary subscriptions;
a sixth set of codes for causing the computer to allocate a traffic channel on the primary subscription;
a seventh set of codes for causing the computer to originate a communication on the one or more secondary subscriptions with the traffic channel;
an eighth set of codes for causing the computer to route the communication though a second call control signaling;
a ninth set of codes for causing the computer to terminate the communication using radio resources based on a termination request from the mobile device; and
a tenth set of codes for causing the computer to release the traffic channel on the primary subscription.

24. At least one processor, comprising:
a first module that receives a registration request on a primary subscription;
a second module that maps the primary subscription to one or more secondary subscriptions;
a third module that creates a radio resource control connection based on the primary subscription; and
a fourth module that decouples call control signaling from the radio resource control connection and establishes a first call control signaling for the primary subscription and a separate call control signaling for each of the one or more secondary subscriptions.

25. The at least one processor of claim 24, further comprising:
a fifth module that performs a high rate packet data authentication, wherein the high rate packet data authentication is common for the primary subscription and the one or more secondary subscriptions; and
a sixth module that authenticates separate point-to-point protocol sessions, or a similar upper layer Internet Protocol signaling, for each of the primary subscription and the one or more secondary subscriptions.

26. A method of employing a processor executing computer executable instructions stored on a computer readable storage medium, comprising:
sending a registration request to a network, wherein the registration request is for a first subscription;
receiving a created radio resource control connection that is based on the first subscription; and
establishing with the network a first call control signaling for the first subscription and a second call control signaling for a second subscription.

27. The method of claim 26, further comprising at least one of:
monitoring pages with the first subscription;
obtaining location information based on a location registration on the first subscription; and
obtaining maintenance information related to the first subscription, wherein the maintenance information is independent of a subscription related signaling.

28. The method of claim 26, further comprising:
receiving, from the network, a page on the first subscription, wherein the page includes an indication that a communication is for the second subscription;
obtaining allocated radio resources on the first subscription after a page reply is sent;
accepting the second call control signaling that indicates the communication is for the second subscription; and
utilizing the second call control signaling to receive the communication.

29. The method of claim 28, further comprising:
conveying, to the network, a call end request, wherein the communication is terminated on the radio resources; and
releasing the radio resources on the first subscription.

30. The method of claim 26, further comprising:
sending a call setup request for the second subscription;
obtaining an allocated traffic channel on the first subscription;
originating a communication on the second subscription with the allocated traffic channel; and
utilizing the second call control signaling to route the communication.

31. The method of claim 30, further comprising:
conveying, to the network, a call end request, wherein the communication is terminated on radio resources; and
releasing the allocated traffic channel on the first subscription.

32. The method of claim 26, wherein the establishing further comprising decoupling the created radio resource control connection from the first call control signaling and the second call control signaling.

33. The method of claim 26, further comprising:
receiving a request to activate or deactivate the first subscription or the second subscription; and
selectively enabling or disabling the first subscription or the second subscription independently based on the request.

34. The method of claim 26, wherein the establishing further comprises:
associating the created radio resource control connection with the second subscription if a communication is intended for the second subscription.

35. The method of claim 26, wherein the first subscription and the second subscription are with a same service provider or with different service providers.

36. A wireless communications apparatus, comprising:
a memory that retains instructions related to conveying a registration request for a first subscription, receiving a radio resource control connection that is based on the first subscription, and establishing a first call control signaling for the first subscription and a second call control signaling for a second subscription, wherein the first subscription and the second subscription are supported by a same operator or different operators; and
a processor, coupled to the memory, configured to execute the instructions retained in the memory.

37. The wireless communications apparatus of claim 36, wherein the memory retains further instructions related to receiving a page on the first subscription, sending a page reply, obtaining allocated radio resources on the first subscription, accepting the second call control signaling that indicates a communication is for the second subscription, and utilizing the second call control signaling to receive the communication.

38. The wireless communications apparatus of claim 37, wherein the memory retains further instructions related to conveying a call end request and releasing the radio resources on the first subscription.

39. The wireless communications apparatus of claim 36, wherein the memory retains further instructions related to sending a call setup request for the second subscription, obtaining an allocated traffic channel on the first subscription, originating a communication on the second subscription with the allocated traffic channel, and utilizing the second call control signaling to route the communication.

40. The wireless communications apparatus of claim 39, wherein the memory retains further instructions related to conveying a call end request, wherein the communication is terminated on radio resources and releasing the allocated traffic channel on the first subscription.

41. The wireless communications apparatus of claim 36, wherein the instructions related to establishing further decouples the radio resource control connection from the first call control signaling and the second call control signaling.

42. A wireless communications apparatus, comprising:
means for sending a registration request to a network, wherein the registration request is for a first subscription;
means for receiving a created radio resource control connection that is based on the first subscription; and
means for establishing with the network a first call control signaling for the first subscription and a second call control signaling for a second subscription.

43. The wireless communications apparatus of claim 42, further comprising:
means for receiving, from the network, a page on the first subscription, wherein the page includes an indication that a communication is for the second subscription;
means for obtaining allocated radio resources on the first subscription after a page reply is sent;
means for accepting the second call control signaling that indicates the communication is for the second subscription; and
means for utilizing the second call control signaling to receive the communication.

44. The wireless communications apparatus of claim 42, further comprising:
means for conveying a call setup request for the second subscription;
means for obtaining an allocated traffic channel on the first subscription;
means for originating a communication on the second subscription with the allocated traffic channel; and
means for utilizing the second call control signaling to route the communication.

45. A computer program product, comprising:
a computer-readable medium comprising:
a first set of codes for causing a computer to send a registration request to a network, wherein the registration request is for a first subscription;
a second set of codes for causing the computer to receive a created radio resource control connection that is based on the first subscription; and
a third set of codes for causing the computer to establish with the network a first call control signaling for the first subscription and a second call control signaling for a second subscription.

46. The computer program product of claim 45, the computer-readable medium further comprising:
a fourth set of codes for causing the computer to receive, from the network, a page on the first subscription, wherein the page includes an indication that a communication is for the second subscription;
a fifth set of codes for causing the computer to obtain allocated radio resources on the first subscription after a page reply is sent;
a sixth set of codes for causing the computer to accept the second call control signaling that indicates the communication is for the second subscription;
a seventh set of codes for causing the computer to utilize the second call control signaling to receive the communication;
an eighth set of codes for causing the computer to convey, to the network, a call end request, wherein the communication is terminated on the radio resources; and
a ninth set of codes for causing the computer to release the radio resources on the first subscription.

47. The computer program product of claim 45, the computer-readable medium further comprising:
a fourth set of codes for causing the computer to send a call setup request for the second subscription;
a fifth set of codes for causing the computer to obtain an allocated traffic channel on the first subscription;
a sixth set of codes for causing the computer to originate a communication on the second subscription with the allocated traffic channel;
a seventh set of codes for causing the computer to utilize the second call control signaling to route the communication;
an eighth set of codes for causing the computer to convey, to the network, a call end request, wherein the communication is terminated on radio resources; and
a ninth set of codes for causing the computer to release the allocated traffic channel on the first subscription.

48. The computer program product of claim 45, wherein the third set of codes further causes the computer to decouple the created radio resource control connection from the first call control signaling and the second call control signaling.

49. At least one processor, comprising:
a first module that sends a registration request to a network, wherein the registration request is for a first subscription and includes information related to at least a second subscription;
a second module that receives a created radio resource control connection that is based on the first subscription; and
a third module that establishes with the network a first call control signaling for the first subscription and a second call control signaling for the second subscription.

50. The at least one processor of claim 49, wherein the third module further decouples the created radio resource control connection from the first call control signaling and the second call control signaling.
